(19) United States
(12) Patent Application Publication
(10) Pub. No.: US 2026/0239348 A1
(43) Pub. Date: Aug. 13, 2026

(54) SIGNALING FOR SIMULTANEOUS UPLINK TRANSMISSION OVER MULTIPLE SOUNDING REFERENCE SIGNAL (SRS)

(71) Applicant: TELEFONAKTIEBOLAGET LM ERICSSON (PUBL), Stockholm (SE)

(72) Inventors: Sven Jacobsson, Göteborg (SE); Chandan Pradhan, Yokohama (JP); Andreas Nilsson, Göteborg (SE); Claes Tidestav, Stockholm (SE); Shiwei Gao, Ottawa (CA)

(21) Appl. No.: 19/124,055

(22) PCT Filed: Nov. 6, 2023
(86) PCT No.: PCT/IB2023/061191

§ 371 Date: Apr. 24, 2025

Related U.S. Application Data
(60) Provisional application No. 63/423,469, filed on Nov. 7, 2022.

(51) Int. Cl. H04W 72/21; H04L 5/00; H04W 72/232

(52) U.S. Cl. CPC H04W 72/21; H04L 5/0051; H04W 72/232

(57) ABSTRACT

Embodiments include methods, electronic device, storage medium, and computer program for transmitting Physical Uplink Shared Channel (PUSCH) simultaneously from one or more UE panels. In one embodiment, the method comprises receiving one or more messages to configure a plurality of sounding reference signal (SRS) resource sets; receiving a downlink control information (DCI) message to trigger a PUSCH transmission, where the DCI message includes an SRS resource set indication field to indicate a PUSCH transmission scheme, wherein the PUSCH transmission scheme is selected from a group of PUSCH transmission schemes that includes two or more of a single transmission and reception point (sTRP) transmission, a spatial division multiplexing (SDM) transmission, and a single frequency network (SFN) transmission; and transmitting on a PUSCH using the PUSCH transmission scheme as indicated in the DCI message.

### CROSS-REFERENCE TO RELATED APPLICATIONS

This application is a 371 of International Application No. PCT/IB2023/061191, filed Nov. 6, 2023, which claims the benefit of U.S. Provisional Application No. 63/423,469, filed Nov. 7, 2022, the disclosures of which are fully incorporated herein by reference.

### TECHNICAL FIELD

Embodiments of the invention relate to the field of wireless networking; and more specifically, to implementing simultaneous uplink transmission over multiple Sounding Reference Signal (SRS) resource sets.

### BACKGROUND ART

In fifth generation (5G), sixth generation (6G), and future networks, multiple Sounding Reference Signal (SRS) resource sets may be supported for simultaneous multi-panel transmission (STxMP) Physical Uplink Shared Channel (PUSCH) transmission. Additionally, multiple SRS resource sets may be supported for codebook (CB) based and non-codebook (NCB) based operations in these networks. For example, up to two Sounding Reference Signal (SRS) resource sets for 8 transmission (TX) CB-based and NCB-based operation may be supported in the 5G networks.

Yet it is an open question as to how to configure precoding and number of layers for such multi-SRS resource set operations. Furthermore, it is also an open question as to how to switch between transmission schemes. For example, the operations are undefined regarding switching between two of (1) single transmission and reception point (sTRP) transmission, (2) spatial division multiplexing (SDM) transmission, and (3) single frequency network (SFN) transmission.

### SUMMARY OF THE INVENTION

Embodiments include methods, electronic device, storage medium, and computer program for transmitting a Physical Uplink Shared Channel (PUSCH) simultaneously from one or more UE panels. In one embodiment, the method comprises receiving (902) one or more messages to configure a plurality of sounding reference signal (SRS) resource sets; receiving (906) a downlink control information (DCI) message to trigger a PUSCH transmission, where the DCI message includes an SRS resource set indication field to indicate a PUSCH transmission scheme, wherein the PUSCH transmission scheme is selected from a group of PUSCH transmission schemes that includes two or more of a single transmission and reception point (sTRP) transmission, a spatial division multiplexing (SDM) transmission, and a single frequency network (SFN) transmission; and transmitting (908) the PUSCH using the PUSCH transmission scheme as indicated in the DCI message.

Embodiments include user equipment (UEs) for transmitting a Physical Uplink Shared Channel (PUSCH) simultaneously from one or more UE panels. In one embodiment, a UE comprises power supply circuitry configured to supply power to processing circuitry and the processing circuitry to perform receiving (902) one or more messages to configure a plurality of sounding reference signal (SRS) resource sets; receiving (906) a downlink control information (DCI) message to trigger a PUSCH transmission, where the DCI message includes an SRS resource set indication field to indicate a PUSCH transmission scheme, wherein the PUSCH transmission scheme is selected from a group of two or more of PUSCH transmission schemes that includes a single transmission and reception point (sTRP) transmission, a spatial division multiplexing (SDM) transmission, and a single frequency network (SFN) transmission; and transmitting (908) the PUSCH using the PUSCH transmission scheme as indicated in the DCI message.

Embodiments include machine-readable storage media for transmitting a Physical Uplink Shared Channel (PUSCH) simultaneously from one or more UE panels. In one embodiment, a machine-readable storage medium store instructions, which when executed by a processor, cause the process to perform receiving (902) one or more messages to configure a plurality of sounding reference signal (SRS) resource sets; receiving (906) a downlink control information (DCI) message to trigger a PUSCH transmission, where the DCI message includes an SRS resource set indication field to indicate a PUSCH transmission scheme, wherein the PUSCH transmission scheme is selected from a group of two or more of PUSCH transmission schemes that includes a single transmission and reception point (sTRP) transmission, a spatial division multiplexing (SDM) transmission, and a single frequency network (SFN) transmission; and transmitting (908) the PUSCH using the PUSCH transmission scheme as indicated in the DCI message.

Embodiments include methods, electronic device, storage medium, and computer program for coordinating transmission of a Physical Uplink Shared Channel (PUSCH) simultaneously from one or more UE panels. In one embodiment, the method comprises configuring (1002) a user equipment (UE) with a plurality of sounding reference signal (SRS) resource sets; determining (1006) a PUSCH transmission scheme for communication with the UE, wherein each of the PUSCH transmission scheme is selected from a group of two or more of transmission schemes including a single transmission and reception point (sTRP) transmission, a spatial division multiplexing (SDM) transmission, and a single frequency network (SFN) transmission; causing (1008) the UE to use the PUSCH transmission scheme through transmitting to the UE a downlink control information (DCI) message in which an SRS resource set indicator field is set to indicate the PUSCH transmission scheme.

Embodiments include network node for coordinating transmission of a Physical Uplink Shared Channel (PUSCH) simultaneously from one or more UE panels. In one embodiment, a network node comprises power supply circuitry configured to supply power to processing circuitry and the processing circuitry to perform configuring (1002) a user equipment (UE) with a plurality of sounding reference signal (SRS) resource sets; determining (1006) a PUSCH transmission scheme for communication with the UE, wherein each of the PUSCH transmission scheme is selected from a group of two or more transmission schemes including a single transmission and reception point (sTRP) transmission, a spatial division multiplexing (SDM) transmission, and a single frequency network (SFN) transmission; causing (1008) the UE to use the PUSCH transmission scheme through transmitting to the UE a downlink control information (DCI) message in which an SRS resource set indicator field is set to indicate the PUSCH transmission scheme.

Embodiments include machine-readable storage media for coordinating transmission of a Physical Uplink Shared Channel (PUSCH) simultaneously from one or more UE panels. In one embodiment, a machine-readable storage medium store instructions, which when executed by a processor, cause the process to perform configuring (1002) a user equipment (UE) with a plurality of sounding reference signal (SRS) resource sets; determining (1006) a PUSCH transmission scheme for communication with the UE, wherein each of the PUSCH transmission scheme is selected from a group of two or more transmission schemes including a single transmission and reception point (sTRP) transmission, a spatial division multiplexing (SDM) transmission, and a single frequency network (SFN) transmission; causing (1008) the UE to use the PUSCH transmission scheme through transmitting to the UE a downlink control information (DCI) message in which an SRS resource set indicator field is set to indicate the PUSCH transmission scheme

The embodiments as described may switch between transmission schemes within a plurality of PUSCH transmission schemes including a single transmission and reception point (sTRP) transmission, a spatial division multiplexing (SDM) transmission, and a single frequency network (SFN) transmission.

### BRIEF DESCRIPTION OF THE DRAWINGS

The invention may be best understood by referring to the following description and accompanying drawings that are used to illustrate embodiments of the invention. In the drawings:

FIG. 1 illustrates a Sounding Reference Signal (SRS) resource allocation in time and frequency within a slot if resourceMapping-r16 is not signaled.

FIG. 2 illustrates single downlink control information (DCI) multiple transmission and reception point (multi-TRP) Physical Uplink Shared Channel (PUSCH) repetitions.

FIG. 3 illustrates two beams mapped to different Physical Uplink Shared Channel (PUSCH) repetitions with a cyclical mapping pattern.

FIG. 4 illustrates two beams mapped to different Physical Uplink Shared Channel (PUSCH) repetitions with a sequential mapping pattern.

FIG. 5 illustrates a schematic example of a UE with two panels (P1 and P2).

FIG. 6 illustrates non-coherent joint-transmission (NC-JT) using simultaneous DL mTRP transmission with multi-panel reception.

FIG. 7 illustrates simultaneous uplink (DL) mTRP transmission with multi-panel reception at the UE.

FIG. 8 illustrates a network node and a UE that perform uplink communication coordination per some embodiments.

FIG. 9 illustrates the operations of a UE for transmitting on a Physical Uplink Shared Channel (PUSCH) from one or more UE panels.

FIG. 10 illustrates the operations of a network node for transmitting on a Physical Uplink Shared Channel (PUSCH) from one or more UE panels per some embodiments.

FIG. 11 illustrates an electronic device implementing adaptive fault remediation per some embodiments.

FIG. 12 illustrates an example of a communication system per some embodiments.

FIG. 13 illustrates a UE per some embodiments.

FIG. 14 illustrates a network node per some embodiments.

FIG. 15 is a block diagram of a host, which may be an embodiment of the host of FIG. 12, per various aspects described herein.

FIG. 16 is a block diagram illustrating a virtualization environment in which functions implemented by some embodiments may be virtualized.

FIG. 17 illustrates a communication diagram of a host communicating via a network node with a UE over a partially wireless connection per some embodiments.

FIG. 18A shows an exemplary signal transmission hierarchy in a wireless network.

FIG. 18B shows resource elements used for data and signaling transmission.

### DETAILED DESCRIPTION

### 1. Applicable Embodiments

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

### 2.1 Introduction

In the time domain, new radio (NR) downlink (DL) and uplink (UL) transmissions are organized into equally sized subframes of 1 millisecond (ms) each. A subframe is further divided into multiple slots of equal duration. The slot length depends on subcarrier spacing. For 15 kHz subcarrier spacing, there is only one slot per subframe. In general, for 15·2^{μ} kHz subcarrier spacing, where μ∈{0, 1, 2, 3, 4}, there are 2^{μ} slots per subframe. Finally, each slot consists of 14 symbols (unless extended cyclic prefix is configured).

In the frequency domain, a system bandwidth is divided into resource blocks (RBs) each corresponding to 12 contiguous subcarriers. One subcarrier during one symbol interval forms one RE.

### 2.1.1 Sounding Reference Signal (SRS)

In NR, SRS is used for providing Channel State Information (CSI) to the next-generation node B (gNB) in the UL. The usage of SRS includes, e.g., deriving the appropriate transmission/reception beams and/or to perform link adaptation (i.e., setting the transmission rank and the Modulation Coding Scheme (MCS)), and for selecting DL (e.g., for PDSCH transmissions) and UL (e.g., for PUSCH transmissions) MIMO precoding.

In LTE and NR, the SRS is configured via Radio Resource Control (RRC), where parts of the configuration can be updated (for reduced latency) through MAC Control Element (MAC-CE) signaling. The configuration includes, for example, the SRS resource allocation (the physical mapping and the sequence to use) as well as the time-domain behavior (aperiodic, semi-persistent, or periodic). For aperiodic SRS transmission, the RRC configuration does not activate an SRS transmission from the UE but instead a dynamic activation trigger is transmitted from the gNB in the DL, via the DCI in the PDCCH which instructs the UE to transmit the SRS once, at a predetermined time.

When configuring SRS transmissions, the gNB configures, through the SRS-Config information element (IE), a set of SRS resources and a set of SRS resource sets, where each SRS resource set contains one or more SRS resources.

### 2.1.1.1 SRS Configuration

Each SRS resource is configured with the following in RRC (see Abstract syntax Notation ASN) code in 3GPP TS 38.331 version 16.1.0).

| | |
|---|---|
| SRS-Resource ::= | SEQUENCE { |
| srs-ResourceId | SRS-ResourceId, |
| nrofSRS-Ports | ENUMERATED {port1, ports2, |

ports4},

| | |
|---|---|
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
      }
    },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |

groupHopping, sequenceHopping },

| | |
|---|---|
| resourceType | CHOICE { |
| aperiodic | SEQUENCE { |

```
        ...
      },
```

| | |
|---|---|
| semi-persistent | SEQUENCE { |
| periodicityAndOffset-sp | SRS- |

```
PeriodicityAndOffset,
        ...
      },
```

| | |
|---|---|
| periodic | SEQUENCE { |
| periodicityAndOffset-p | SRS- |

```
PeriodicityAndOffset,
        ...
      }
    },
```

| | |
|---|---|
| sequenceId | INTEGER (0..1023), |
| spatialRelationInfo | SRS-SpatialRelationInfo |

```
  OPTIONAL, -- Need R
    ...,
    [[
```

| | |
|---|---|
| resourceMapping-r16 | SEQUENCE { |
| startPosition-r16 | INTEGER (0..13), |
| nrofSymbols-r16 | ENUMERATED {n1, n2, n4}, |
| repetitionFactor-r16 | ENUMERATED {n1, n2, n4} |
| } | OPTIONAL-- Need R |

]]
}

An SRS resource is configurable with respect to, e.g.,
1) The number of SRS ports (1, 2, or 4), configured by the RRC parameter nrofSRS-Ports.
2) The transmission comb (i.e., mapping to every 2nd or 4th subcarrier), configured by the RRC parameter transmissionComb, which includes:
   (1) The comb offset, configured by the RRC parameter combOffset, is specified (i.e., which of the combs that should be used).
   (2) The cyclic shift, configured by the RRC parameter cyclicShift, that configures a (port-specific, for multi-port SRS resources) cyclic shift for the Zadoff-Chu sequence that is used for SRS. The use of cyclic shifts increases the number of SRS resources that can be mapped to a comb (as SRS sequences are designed to be (almost) orthogonal under cyclic shifts), but there is a limit on how many cyclic shifts that can be used (8 for comb 2 and 12 for comb 4).
3) The time-domain position within a given slot, configured with the RRC parameter resourceMapping, which includes:
   (1) The time-domain start position, which is limited to be one of the last 6 symbols (in NR Rel-15) or in any of the 14 symbols in a slot (in NR Rel-16), configured by the RRC parameter startPosition.
   (2) The number of symbols for the SRS resource (that can be set to 1, 2 or 4), configured by the RRC parameter nrofSymbols.
   (3) The repetition factor (that can be set to 1, 2 or 4), configured by the RRC parameter repetitionFactor. When the repetition factor is larger than 1, the same frequency resources are used multiple times across symbols, used to improve the coverage as this allows more energy to be collected by the receiver.
4) The sounding bandwidth, frequency-domain position and shift, and frequency-hopping pattern of an SRS resource (i.e., which part of the transmission bandwidth that is occupied by the SRS resource) is set through the RRC parameters freqDomainPosition, freqDomainShift, and the freqHopping parameters c-SRS, b-SRS, and b-hop. The smallest possible sounding bandwidth is 4 RBs.
5) The RRC parameter resourceType determines whether the SRS resource is transmitted as periodic, aperiodic (singe transmission triggered by DCI), or semi persistent (same as periodic except for the start and stop of the periodic transmission is controlled through MAC-CE signaling instead of RRC signaling).
6) The RRC parameter sequenceId specifies how the SRS sequence is initialized.
7) The RRC parameter spatialRelationInfo configures the spatial relation for the SRS beam with respect to another RS (which could be another SRS, an SSB or a CSI-RS). If an SRS resource has a spatial relation to another SRS resource, then this SRS resource should be transmitted with the same beam (i.e., virtualization) as the indicated SRS resource.

An illustration of how an SRS resource could be allocated in time and frequency within a slot (note that semi-persistent/periodic SRS resources typically span several slots), is provided in Error! Reference source not found.. In NR Rel-16, the additional (and optional) RRC parameter resourceMapping-r16 was introduced. If resourceMapping-r16 is signaled, the UE shall ignore the RRC parameter resourceMapping. The difference between resourceMapping-r16 and resourceMapping is that the SRS resource (for which the number of OFDM symbols and the repetition factor is still limited to 4) can start in any of the 14 OFDM symbols in a slot configured by the RRC parameter startPosition-r16.

An SRS resource set is configured with the following in RRC (see ASN code in 3GPP TS 38.331 version 16.1.0).

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS- |
| ResourcesPerSet)) OF SRS-ResourceId | OPTIONAL, -- Cond Setup |
| resourceType | CHOICE { |
| aperiodic | SEQUENCE { |
| aperiodicSRS-ResourceTrigger | INTEGER (1..maxNrofSRS- |

TriggerStates-1),

| | |
|---|---|
| csi-RS | NZP-CSI-RS-ResourceId |

OPTIONAL, -- Cond NonCodebook

| | |
|---|---|
| slotOffset | INTEGER (1..32) |

```
OPTIONAL, -- Need S
      ...,
      [[
```

| | |
|---|---|
| aperiodicSRS-ResourceTriggerList | SEQUENCE |

(SIZE(1..maxNrofSRS-TriggerStates-2))

OF INTEGER

| | |
|---|---|
| (1..maxNrofSRS-TriggerStates-1) | OPTIONAL -- Need M |

```
      ]]
    },
```

| | |
|---|---|
| semi-persistent | SEQUENCE { |
| associatedCSI-RS | NZP-CSI-RS-ResourceId |

```
OPTIONAL, -- Cond NonCodebook
      ...
    },
```

| | |
|---|---|
| periodic | SEQUENCE { |
| associatedCSI-RS | NZP-CSI-RS-ResourceId |

```
OPTIONAL, -- Cond NonCodebook
      ...
    }
  },
```

| | |
|---|---|
| usage | ENUMERATED {beamManagement, |

codebook, nonCodebook, antennaSwitching},

| | |
|---|---|
| alpha | Alpha |

OPTIONAL, -- Need S

| | |
|---|---|
| p0 | INTEGER (−202..24) |

OPTIONAL, -- Cond Setup

| | |
|---|---|
| pathlossReferenceRS | PathlossReferenceRS-Config |

OPTIONAL, -- Need M

| | |
|---|---|
| srs-PowerControlAdjustmentStates | ENUMERATED { sameAsFci2, |

| | |
|---|---|
| separateClosedLoop} | OPTIONAL, -- Need S |

```
  ...,
  [[
```

| | |
|---|---|
| pathlossReferenceRSList-r16 | SetupRelease { |

| | |
|---|---|
| PathlossReferenceRSList-r16} | OPTIONAL -- Need M |

]]
}

SRS resource(s) will be transmitted as part of an SRS resource set, where all SRS resources in the same SRS resource set must share the same resource type. An SRS resource set is configurable with respect to, e.g.,
1) For aperiodic SRS, the slot offset is configured by the RRC parameter slotOffset and sets the delay from the PDCCH trigger reception to the start of the SRS transmission.
2) The resource usage, which is configured by the RRC parameter usage sets constraints and assumptions on the resource properties (see 3GPP TS 38.214 for further details). SRS resource sets can be configured with one of four different usages: ‘antennaSwitching’, ‘codebook’, ‘nonCodebook’ and ‘beamManagement’.
3) An SRS resource set that is configured with usage ‘antennaSwitching’ is used for reciprocity-based DL precoding (i.e., used to sound the channel in the UL so that the gNB can use reciprocity to set a suitable DL precoders). The UE is expected to transmit one SRS port per UE antenna port.
   (1) An SRS resource set that is configured with usage ‘codebook’ is used for CB-based UL transmission (i.e., used to sound the different UE antennas and help the gNB to determine/signal a suitable UL precoder, transmission rank, and MCS for PUSCH transmission). There are up to two SRS resources in an SRS resource set with usage ‘codebook’. How SRS ports are mapped to UE antenna ports is, however, up to UE implementation and not known to the gNB.
   (2) An SRS resource set that is configured with usage ‘nonCodebook’ is used for NCB-based UL transmission. Specifically, the UE transmits one SRS resource per candidate beam (suitable candidate beams are determined by the UE based on CSI-RS measurements in the DL and, hence, reciprocity needs to hold). The gNB can then, by indicating a subset of these SRS resources, determine which UL beam(s) that the UE should apply for PUSCH transmission. One UL layer will be transmitted per indicated SRS resource. Note that how the UE maps SRS ports to antenna ports is up to UE implementation and not known to the gNB.
4) The associated CSI-RS (this configuration is only applicable for NCB-based UL transmission) for each of the possible resource types.
   (1) For an aperiodic SRS, the associated CSI-RS resource is set by the RRC parameter csi-RS.
   (2) For semi-persistent/periodic SRS, the associated CSI-RS resource is set by the RRC parameter associatedCSI-RS.
5) The PC parameters, e.g., alpha and p0 are used for setting the SRS transmission power. SRS has its own UL PC scheme in NR (see 3GPP TS 38.213 for further details), which specifies how the UE should split the available output power between two or more SRS ports during one SRS transmit occasion (an SRS transmit occasion is a time window within a slot where SRS transmission is performed).

To summarize, the SRS resource-set configuration determines, e.g., usage, power control, and slot offset for aperiodic SRS. The SRS resource configuration determines the time-and-frequency allocation, the periodicity and offset, the sequence, and the spatial-relation information.

### 2.1.2 Uplink (UL) Transmission/Precoding Schemes

The channel that carries data in the NR UL is called PUSCH. In NR, there are two possible waveforms that can be used for PUSCH: Cyclic Prefix—Orthogonal Frequency Division Multiplexing (CP-OFDM) and Discrete Fourier Transform Spread OFDM (DFT-S-OFDM). CP-OFDM is used as the access technology in downlink and uplink chains in the physical layer for 5G New Radio system. Its operation is very similar to that of OFDM used in LTE, however CP-OFDM features variable subcarrier spacing termed “numerology”. Where LTE uses a fixed 15 kHz subcarrier separation, CP-OFDM can utilize 15 kHz, 30 kHz, 60 kHz, 120 kHz, etc. When the subcarrier spacing is changed, the cyclic prefix duration per symbol also changes. DFT-S-OFDM is used in uplink chain in the physical layer for 5G NR system as used in the LTE uplink and it may be used for power limited scenario and single layer transmission.

Also, there are two transmission schemes specified for PUSCH: codebook (CB)-based precoding and NCB-based precoding.

The gNB configures, in RRC, the transmission scheme through the higher-layer parameter txConfig in the PUSCH-Config IE. CB-based transmission can be used for non-calibrated UEs and/or for FDD (i.e., UL/DL reciprocity does not need to hold). NCB-based transmission, on the other hand, relies on UL/DL reciprocity and is, hence, intended for TDD.

### 2.1.2.1 CB-Based Precoding

In closed-loop precoding for the NR uplink, a network node such as a gNB transmits, based on channel measurements in the reverse link (uplink), Transmit Precoding Matrix Index (TPMI) to the UE, which it should apply over a number of SRS ports. The gNB configures the UE to transmit SRS according to the number of UE antennas it would like the UE to use for uplink transmission to enable the channel measurements.

CB-based PUSCH is enabled if the higher-layer parameter txConfig is set to ‘codebook’. For dynamically scheduled PUSCH with configured grant type 2, CB-based PUSCH transmission can be summarized in the following steps:
1. The UE transmits SRS, configured in an SRS resource set with higher-layer parameter usage in SRS-Config IE set to ‘codebook’. Up to two SRS resources (for testing up to two virtualizations/beams/panels) each with up to four ports, can be configured in the SRS resource set.
2. The gNB determines the number of layers (or rank) and a preferred precoder (i.e., TPMI) from a codebook subset based on the received SRS from one of the SRS resources. The codebook subset is configured via the higher-layer parameter codebookSubset, based on reported UE capability, and is one of
   fully coherent (‘fullyAndPartialAndNonCoherent’), or
   partially coherent (‘partialAndNonCoherent’), or
   non-coherent (‘nonCoherent’),
3. If two SRS resources are configured in the SRS resource set, the gNB indicates the selected SRS resource via a 1-bit SRI field in the DCI scheduling the PUSCH transmission. If only one SRS resource is configured in the SRS resource set, the SRI field is not indicated in DCI.
4. The gNB indicates, via DCI, the number of layers and the TPMI. DM-RS port(s) associated with the layer(s) are also indicated in DCI. The number of bits in DCI used for indicating the number of layers (if transform precoding is enabled, the number of PUSCH layers is limited to 1) and the TPMI is determined as follows (unless UL full-power transmission is configured, for which the number of bits may vary):
   4, 5, or 6 bits if the number of antenna ports is 4, if transform precoding is disabled, and if the higher-layer parameter maxRank in PUSCH-Config IE is set to 2, 3, or 4 (see Error! Reference source not found.).
   2, 4, or 5 bits if the number of antenna ports is 4, if transform precoding is disabled or enabled, and if the higher-layer parameter maxRank in PUSCH-Config IE is set to 1 (see Error! Reference source not found.).
   2 or 4 bits if the number of antenna ports is 2, if transform precoding is disabled, and if the higher-layer parameter maxRank in PUSCH-Config IE is set to 2 (see Error! Reference source not found.).
   1 or 3 bits if the number of antenna ports is 2, if transform precoding is disabled or enabled, and if the higher-layer parameter maxRank in PUSCH-Config IE is set to 1 (see Error! Reference source not found.).
   0 bits if 1 antenna port is used for PUSCH transmission.
5. The UE performs PUSCH transmission over the antenna ports corresponding to the SRS ports in the indicated SRS resource.

TABLE 1
Precoding information and number of layers, for 4 antenna ports, if transform precoding is
disabled and maxRank = 2, 3 or, 4 (reproduced from Table 7.3.1.1.2-2 of 3GPP TS 38.212)

| Bit | | Bit | | Bit | |
|---|---|---|---|---|---|
| field | | field | | field | |
| mapped | | mapped | | mapped | |
| to | codebookSubset = | to | codebookSubset = | to | codebookSubset = |
| index | fullyAndPartialAndNonCoherent | index | partialAndNonCoherent | index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 2 layers: TPMI = 0 | 4 | 2 layers: TPMI = 0 | 4 | 2 layers: TPMI = 0 |
| . . . | . . . | . . . | . . . | . . . | . . . |
| 9 | 2 layers: TPMI = 5 | 9 | 2 layers: TPMI = 5 | 9 | 2 layers: TPMI = 5 |
| 10 | 3 layers: TPMI = 0 | 10 | 3 layers: TPMI = 0 | 10 | 3 layers: TPMI = 0 |
| 11 | 4 layers: TPMI = 0 | 11 | 4 layers: TPMI = 0 | 11 | 4 layers: TPMI = 0 |
| 12 | 1 layer: TPMI = 4 | 12 | 1 layer: TPMI = 4 | 12-15 | reserved |
| . . . | . . . | . . . | . . . | | |
| 19 | 1 layer: TPMI = 11 | 19 | 1 layer: TPMI = 11 | | |
| 20 | 2 layers: TPMI = 6 | 20 | 2 layers: TPMI = 6 | | |
| . . . | . . . | . . . | . . . | | |
| 27 | 2 layers: TPMI = 13 | 27 | 2 layers: TPMI = 13 | | |
| 28 | 3 layers: TPMI = 1 | 28 | 3 layers: TPMI = 1 | | |
| 29 | 3 layers: TPMI = 2 | 29 | 3 layers: TPMI = 2 | | |
| 30 | 4 layers: TPMI = 1 | 30 | 4 layers: TPMI = 1 | | |
| 31 | 4 layers: TPMI = 2 | 31 | 4 layers: TPMI = 2 | | |
| 32 | 1 layer: TPMI = 12 | | | | |
| . . . | . . . | | | | |
| 47 | 1 layer: TPMI = 27 | | | | |
| 48 | 2 layers: TPMI = 14 | | | | |
| . . . | . . . | | | | |
| 55 | 2 layers: TPMI = 21 | | | | |
| 56 | 3 layers: TPMI = 3 | | | | |
| . . . | . . . | | | | |
| 59 | 3 layers: TPMI = 6 | | | | |
| 60 | 4 layers: TPMI = 3 | | | | |
| 61 | 4 layers: TPMI = 4 | | | | |
| 62-63 | reserved | | | | |

TABLE 2
Precoding information and number of layers, for 4 antenna ports, if transform precoding
is disabled/enabled and maxRank = 1 (reproduced from Table 7.3.1.1.2-3 of 3GPP TS 38.212)

| Bit | | Bit | | Bit | |
|---|---|---|---|---|---|
| field | | field | | field | |
| mapped | | mapped | | mapped | |
| to | codebookSubset = | to | codebookSubset = | to | codebookSubset = |
| index | fullyAndPartialAndNonCoherent | index | partialAndNonCoherent | index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 1 layer: TPMI = 4 | 4 | 1 layer: TPMI = 4 | | |
| . . . | . . . | . . . | . . . | | |
| 11 | 1 layer: TPMI = 11 | 11 | 1 layer: TPMI = 11 | | |
| 12 | 1 layer: TPMI = 12 | 12-15 | reserved | | |
| . . . | . . . | | | | |
| 27 | 1 layer: TPMI = 27 | | | | |
| 28-31 | reserved | | | | |

TABLE 3
Precoding information and number of layers, for 2 antenna
ports, if transform precoding is disabled and maxRank =
2 (reproduced from Table 7.3.1.1.2-4 of 3GPP TS 38.212)

| Bit field | | Bit field | |
|---|---|---|---|
| mapped | codebookSubset = | mapped | codebookSubset = |
| to index | fullyAndPartialAndNonCoherent | to index | nonCoherent |
| 0 | 1 layer: TPMI = 0 | 0 | 1 layer: TPMI = 0 |
| 1 | 1 layer: TPMI = 1 | 1 | 1 layer: TPMI = 1 |
| 2 | 2 layers: TPMI = 0 | 2 | 2 layers: TPMI = 0 |
| 3 | 1 layer: TPMI = 2 | 3 | reserved |
| 4 | 1 layer: TPMI = 3 | | |
| 5 | 1 layer: TPMI = 4 | | |
| 6 | 1 layer: TPMI = 5 | | |
| 7 | 2 layers: TPMI = 1 | | |
| 8 | 2 layers: TPMI = 2 | | |
| 9-15 | reserved | | |

TABLE 4
Precoding information and number of layers, for 2 antenna ports,
if transform precoding is disabled/enabled and maxRank =
1 (reproduced from Table 7.3.1.1.2-5 of 3GPP TS 38.212)

| Bit field | | Bit field | |
|---|---|---|---|
| mapped | codebookSubset = | mapped | codebookSubset = |
| to index | fullyAndPartialAndNonCoherent | to index | nonCoherent |
| 0 | 1 layer: TPMI = 0 | 0 | 1 layer: TPMI = 0 |
| 1 | 1 layer: TPMI = 1 | 1 | 1 layer: TPMI = 1 |
| 2 | 1 layer: TPMI = 2 | | |
| 3 | 1 layer: TPMI = 3 | | |
| 4 | 1 layer: TPMI = 4 | | |
| 5 | 1 layer: TPMI = 5 | | |
| 6-7 | reserved | | |

For a given number of layers, the TPMI field indicates a precoding matrix that UE should use for PUSCH. In a first example, if the number of antenna ports is 4, the number of layers is 1, and transform precoding is disabled then the set of possible precoding matrices is shown in Error! Reference source not found.. In a second example, if the number of antenna ports is 4, the number of layers is 4, and transform precoding is disabled then the set of possible precoding matrices is shown in Error! Reference source not found..

TABLE 5
Precoding matrix, W, for single-layer transmission using four antenna ports when
transform precoding is disabled (reproduced from Table 6.3.1.5-3 of 3GPP TS 38.211).

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}l \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 6
Precoding matrix, W, for four-layer transmission using four antenna ports when
transform precoding is disabled (reproduced from Table 6.3.1.5-7 of 3GPP TS 38.211).

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

### 2.1.2.2 NCB-Based Precoding

NCB-based UL transmission is for reciprocity-based UL transmission in which SRS precoding is derived at a UE based on CSI-RS received in the DL. Specifically, the UE measures received CSI-RS and deduces suitable precoder weights for SRS transmission(s), resulting in one or more (virtual) SRS ports, each corresponding to a spatial layer.

A UE can be configured up to four SRS resources, each with a single (virtual) SRS port, in an SRS resource set with higher-layer parameter usage in SRS-Config IE set to ‘nonCodebook’. A UE transmits up to four SRS resources and the gNB measures the UL channel based on the received SRS and determines the preferred SRS resource(s). Next, the gNB indicates the selected SRS resources via the SRS Resource Indicator (SRI) field in DCI and the UE uses this information to precode PUSCH with a transmission rank that equals the number of indicated SRS resources (and, hence, the number of SRS ports).

The SRI field in DCI is described in 3GPP TS 38.212 as follows (references in the following refers to tables in 3GPP TS 38.212):

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉$$

or ┌log₂ N_{SRS}┐ bits, where N_{SRS} is the number of configured SRS resources in the SRS resource set configured by higher layer parameter srs-ResourceSetToAddModList, and associated with the higher layer parameter usage of value ‘codebook’ or ‘nonCodebook’,

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ bits$$

according to Tables 7.3.1.1.2-28/29/30/31 if the higher layer parameter txConfig=nonCodebook, where N_{SRS} is the number of configured SRS resources in the SRS resource set configured by higher layer parameter srs-ResourceSetToAddModList, and associated with the higher layer parameter usage of value ‘nonCodebook’ and
if UE supports operation with maxMIMO-Layers and the higher layer parameter maxMIMO-Layers of PUSCH-ServingCellConfig of the serving cell is configured, Lₘₐₓ is given by that parameter
otherwise, Lₘₐₓ is given by the maximum number of layers for PUSCH supported by the UE for the serving cell for non-codebook based operation.
┌log₂ N_{SRS}┐ bits according to Tables 7.3.1.1.2-32, 7.3.1.1.2-32A and 7.3.1.1.2-32B if the higher layer parameter txConfig=codebook, where N_{SRS} is the number of configured SRS resources in the SRS resource set configured by higher layer parameter srs-ResourceSetToAddModList and associated with the higher layer parameter usage of value ‘codebook’.

### 2.1.3 Rel-17 Multiple Transmit/Receive Point (Multi-TRP) PUSCH Repetition

Single-DCI multi-TRP PUSCH repetition was introduced in NR Rel-17 (e.g., as illustrated in Error! Reference source not found.). With this scheme, the same PUSCH is transmitted, in two or more different slots in a TDM fashion, to two different TRPs. Both CB and NCB operation is supported and the same number of PUSCH layers (up to four) will be transmitted in each of the slots. To enable such PUSCH repetition, a UE can be configured with up to two SRS resource sets (with the same number of SRS resources and SRS ports) with the same usage. Here, each SRS resource set is associated with a different TRP. The two beams are mapped to different PUSCH repetitions with either a cyclical mapping pattern (see Error! Reference source not found.) or a sequential mapping pattern (see Error! Reference source not found.). As the path loss to different TRPs may be significantly different, per-TRP power control can be configured (i.e., separate power control for each SRS resource set).

Dynamic switching between single-TRP PUSCH transmission and multi-TRP PUSCH repetition is supported. To enable such dynamic switching, a new 2-bit “SRS resource set indicator” field is introduced in DCI format 01 (and DCI format 0_2). The following excerpt from 3GPP TS 38.212 describes this new field:
SRS resource set indicator—0 or 2 bits
   2 bits according to Table 7.3.1.1.2-36 if
      txConfig=nonCodebook, and there are two SRS resource sets configured by srs-ResourceSetToAddModList and associated with the usage of value ‘nonCodebook’, or
      txConfig=codebook, and there are two SRS resource sets configured by srs-ResourceSetToAddModList and associated with usage of value ‘codebook’;
   0 bit otherwise.

Error! Reference source notfound. shows the codepoints (indices) ofthe new SRS resource set indicator field. Here, the first two indices correspond to single PUSCH transmission to a first and second TRP (i.e., to a first and second SRS resource set) and the last two indices correspond to PUS CH repetition to both TRPs. The difference between the last two states is the mapping between a first and a second SRS resource indicator field (and a first and second “precoding information . . . ” field for CB-based operation), i.e., in which order the SRS resource sets should be transmitted (see description below). The SRS resource set with lower ID is the first SRS resource set, and the other SRS resource set is the second SRS resource set.

TABLE 7
SRS resource set indication (reproduced from
Table 7.3.1.1.2-36 in 3GPP TS 38.212)

| Bit field | |
|---|---|
| mapped | |
| to index | SRS resource set indication |
| 0 | SRS resource indicator field and Precoding information |
| | and number of layers field are associated with the first |
| | SRS resource set; |
| | Second SRS resource indicator field and Second |
| | Precoding information field are reserved. |
| 1 | SRS resource indicator field and Precoding information |
| | and number of layers field are associated with the |
| | second SRS resource set; |
| | Second SRS resource indicator field and Second |
| | Precoding information field are reserved. |
| 2 | SRS resource indicator field and Precoding information |
| | and number of layers field are associated with the first |
| | SRS resource set; |
| | Second SRS resource indicator field and Second |
| | Precoding information field are associated with the |
| | second SRS resource set. |
| 3 | SRS resource indicator field and Precoding information |
| | and number of layers field are associated with the first |
| | SRS resource set; |
| | Second SRS resource indicator field and Second |
| | Precoding information field are associated with the |
| | second SRS resource set. |

When two SRS resource sets are configured in srs-ResourceSetToAddcModlList or srs-ResourceSetToAddcModlListDCI-0-2 with higher layer parameter usage in SRS-ResourceSet set to ‘codebook’ or ‘noncodebook’, for PUSCH repetition Type A, in case K>1 (where K is the number of repetitions), the same symbol allocation is applied across the K consecutive slots and the PUSCH is limited to a single transmission layer. The UE shall repeat the transport block (TB) across the K consecutive slots applying the same symbol allocation in each slot, and the association of the first and second SRS resource set in srs-ResourceSetToAddModList or srs-ResourceSetToAddModListDCI-0-2 to each slot is determined as follows:
if a DCI format 0_1 or DCI format 0_2 indicates codepoint “00” for the SRS resource set indicator, the first SRS resource set is associated with all K consecutive slots,
if a DCI format 0_1 or DCI format 0_2 indicates codepoint “01” for the SRS resource set indicator, the second SRS resource set is associated with all K consecutive slots,
if a DCI format 0_1 or DCI format 0_2 indicates codepoint “10” for the SRS resource set indicator, the first and second SRS resource set association to K consecutive slots is determined as follows:
   When K=2, the first and second SRS resource sets are applied to the first and second slot of 2 consecutive slots, respectively.
   When K>2 and cyclicMapping in PUSCH-Config is enabled, the first and second SRS resource sets are applied to the first and second slot of K consecutive slots, respectively, and the same SRS resource set mapping pattern continues to the remaining slots of K consecutive slots.
   When K>2 and sequentialMapping in PUSCH-Config is enabled, first SRS resource set is applied to the first and second slots of K consecutive slots, and the second SRS resource set is applied to the third and fourth slot of K consecutive slots, and the same SRS resource set mapping pattern continues to the remaining slots of K consecutive slots.
Otherwise, a DCI format 0_1 or DCI format 0_2 indicates codepoint “11” for the SRS resource set indicator, and the first and second SRS resource set association to K consecutive slots is determined as follows:
   When K=2, the second and first SRS resource set are applied to the first and second slot of 2 consecutive slots, respectively.
   When K>2 and cyclicMapping in PUSCH-Config is enabled, the second and first SRS resource sets are applied to the first and second slot of K consecutive slots, respectively, and the same SRS resource set mapping pattern continues to the remaining slots of the K consecutive slots.
   When K>2 and sequentialMapping in PUSCH-Config is enabled, the second SRS resource set is applied to the first and second slot of K consecutive slots, and the first SRS resource set is applied to the third and fourth slot of K consecutive slots, and the same SRS resource set mapping pattern continues to the remaining slots of the K consecutive slots.

For PUSCH repetition Type B, when two SRS resource sets are configured in srs-ResourceSetToAddModList or srs-ResourceSetToAddModListDCI-0-2 with higher layer parameter usage in SRS-ResourceSet set to ‘codebook’ or ‘noncodebook’, the SRS resource set association to nominal PUSCH repetitions follows the same method as SRS resource set association to slots in PUSCH Type A repetition by considering nominal repetitions instead of slots.

### 2.1.3.1 CB-Based Multi-TRP PUSCH Repetition

For CB-based operation, different TPMIs may be indicated for PUSCH transmission towards different TRPs. Indeed, it is unlikely that the same precoder is suitable for transmission to different TRPs. As described in Section Error! Reference source not found., for single-TRP PUSCH, the precoding information and number of layers is indicated via a single “Precoding information and number of layers” field in DCI.

For multi-TRP PUSCH repetition, since the number of layers towards each TRP must be the same, it is sufficient to indicate the number of layers only for one of the SRS resource sets:
For one of the SRS resource sets, the legacy “Precoding information and number of layers field” will be used.
For the other SRS resource set, it is sufficient to indicate only the precoder for a given number of layers, which reduces overhead. A new “Second precoding information” field is introduced for this purpose. The size of this field varies between 0-5 bits depending on the number of antenna ports, UE coherency, etc.

In Table 1, we show an example the “Second precoding information” field for the case when if the number of antenna ports per PUSCH transmission is 2, if transform precoding is disabled, and if the maximum rank is set to 2. Note that the length of this field is 1-3 bits depending on UE coherency and the number of layers that is indicated in a first “Precoding information and number of layers field”, which is less than the 2-4 bits needed to convey both rank and precoder (cf. Error! Reference source not found.).

TABLE 1
Second precoding information and number of layers, for 2 antenna
ports, if transform precoding is disabled and maxRank =
2 (reproduced from Table 7.3.1.1.2-4B of 3GPP TS 38.212).

| Bit field | | Bit field | |
|---|---|---|---|
| mapped | codebookSubset = | mapped | codebookSubset = |
| to index | fullyAndPartialAndNonCoherent | to index | nonCoherent |
| 0 | 1 layer: TPMI = 0 | 0 | 1 layer: TPMI = 0 |
| 1 | 1 layer: TPMI = 1 | 1 | 1 layer: TPMI = 1 |
| . . . | . . . | 0 | 2 layers: TPMI = 0 |
| 5 | 1 layer: TPMI = 5 | 1 | 2 layers: reserved |
| 6-7 | 1 layer: reserved | | |
| 0 | 2 layers: TPMI = 0 | | |
| . . . | . . . | | |
| 2 | 2 layers: TPMI = 2 | | |
| 3-7 | 2 layers: reserved | | |

### 2.1.3.2 NCB-Based Multi-TRP PUSCH Repetition

For NCB, different SRS resources may be indicated for PUSCH transmission towards different TRPs. For this reason, a second SRI field is added to the DCI. Since the number of layers must be the same for the second SRS resource set as for the first SRS resource set, the second SRI field may be shorter than the first SRI field. Indeed, the number of indicated SRS resources can be inferred from the first SRI field. Specifically, the second SRI field in DCI is described in 3GPP TS 38.212 as follows (references in the following refers to tables in 3GPP TS 38.212):
Second SRS resource indicator—

$$0 , ⌈ {log}_{2} ( {max}_{k ∈ \{ 1 , 2 , … , min \{ {L}_{max} , {N}_{SRS} \} \}} ( \begin{matrix}{N}_{SRS} \\ k\end{matrix} ) ) ⌉$$

or ┌log₂(NSRS)┐ bits,

$$⌈ {log}_{2} ( {max}_{k ∈ \{ 1 , 2 , … , min \{ {L}_{max} , {N}_{SRS} \} \}} ( \begin{matrix}{N}_{SRS} \\ k\end{matrix} ) ) ⌉ bits$$

according to Tables 7.3.1.1.2-28/29A/30A/31A with the same number of layers indicated by SRS resource indicator field if the higher layer parameter txConfig=nonCodebook and SRS resource set indicator field is present, where N_{SRS} is the number of configured SRS resources in the second SRS resource set, and
   if UE supports operation with maxMIMO-Layers and the higher layer parameter maxMIMO-Layers of PUSCH-ServingCellConfig of the serving cell is configured, Lₘₐₓ is given by that parameter
   otherwise, Lₘₐₓ is given by the maximum number of layers for PUSCH supported by the UE for the serving cell for non-codebook based operation.
┌log₂(N_{SRS})┐ bits according to Tables 7.3.1.1.2-32, 7.3.1.1.2-32A and 7.3.1.1.2-32B if the higher layer parameter txConfig=codebook and SRS resource set indicator field is present, where N_{SRS} is the number of configured SRS resources in the second SRS resource set.
0 bit otherwise.

### 2.1.4 Rel-18 Simultaneous Multi-Panel Transmission (STxMP)

In NR up to Rel-17, the discussions regarding UL transmission for FR2 has mainly been for a UE with single panel transmission (transmission from a single UE panel at each time instance). In NR-Rel 18, it has been agreed to specify support for up to two simultaneously transmitting UE panels. Specifically, it has been agreed that SDM (for which different layers of a same transmission are transmitted from different panels) and SFN (for which same layers are transmitted from both supported) will be supported for single-DCI STxMP.

There are discussions ongoing in 3GPP on how to support dynamic switching between STxMP transmission modes and single UE panel (sTRP) transmission, as captured by the following agreement:

### Agreement

Support dynamic switching between SDM scheme of single-DCI based STxMP PUSCH and sTRP transmission
For further study (FFS) the indication of dynamic switching
FFS: max number of layers when switching to sTRP transmission

Similarly, there are discussions whether to support dynamic switching between STxMP and the multi-TRP PUSCH repetition schemes specified in Rel-17 (see Section 0):

### Agreement

For the switching between SDM scheme of single-DCI based STxMP PUSCH and Rel-17 mTRP PUSCH TDM scheme, Alt2 is supported. FFS: Whether Alt is supported in addition to Alt2.
Alt1: Support dynamic switching between SDM scheme of single-DCI based STxMP PUSCH and Rel-17 mTRP PUSCH TDM scheme
   FFS: how to support dynamic switching, e.g., using the indicated PUSCH repetition number
   Note: It is up to gNB implementation to configure SDM scheme of single-DCI based STxMP PUSCH or Rel-17 mTRP PUSCH TDM scheme or both of them in RRC. Dynamic switching between them is only when both schemes are configured in RRC.
Alt2: Support RRC-based switching between SDM scheme of single-DCI based STxMP PUSCH and Rel-17 mTRP PUSCH TDM scheme.

There are also discussions in 3GPP regarding number of supported layer combinations (L₁,L₂), where Lₘ is the number of layers transmitted from the mth UE panel, for STxMP, where the most likely outcome is to support the following candidate number of layers: (1,1), (1,2), (2,1) and (2,2). In addition, it is being discussed whether the number of layers per panel should be up to 2 or up to 4 when switching to sTRP transmission.

Finally, it has been agreed that two SRS resource sets will be used for both CB-based and NCB-based operation, as per the following agreement:

### Agreement

For SDM scheme of single-DCI based STxMP PUSCH
Configure two SRS resource sets for CB or NCB.
   FFS: These two SRS resource sets can have different number of SRS resources for codebook-based or non-codebook based.
For codebook-based PUSCH, DCI indicates two TPMI fields, and each TPMI field separately indicates the precoding information and the number of layers conveyed over the SRS ports of the indicated SRS resource in each SRS resource set.
For non-codebook based PUSCH and codebook-based PUSCH, DCI indicates two SRI fields, and each field indicates SRS resource(s) for each SRS resource set separately.
   FFS: For codebook-based PUSCH, the two SRS resources indicated by the two SRI fields can have different number of SRS ports

### 2.1.5 Rel-18 8 Tx UL Transmission

As explained in Section Error! Reference source not found., legacy NR CB-based and NCB-based UL transmission is limited to up to 4 ports (and up to 4 layers). For NR Rel-18, it is discussed to support up to 8 ports (and, possibly, more than 4 layers) for UL transmission. Specifically, the NR Rel-18 WID includes the following objective.

### Objective:

Study, and if justified, specify UL DMRS, SRS, SRI, and TPMI (including codebook) enhancements to enable 8 Tx UL operation to support 4 and more layers per UE in UL targeting CPE/FWA/vehicle/Industrial devices.
Note: Potential restrictions on the scope of this objective (including coherence assumption, full/non-full power modes) will be identified as part of the study.

An open question is whether two SRS resource sets will be supported for 8 Tx NCB-based and CB-based transmission, as captured by the following agreements:

### Agreement

For SRS configuration required for non-codebook-based UL transmission by an 8TX UE, Alt is supported, that is
Alt1: A single SRS resource set configured with up to 8 single-port SRS resources
FFS: Configuration of up to two, or four SRS resource sets, each configured with up to 4, or 2 single-port SRS resources, respectively.

### Agreement

For SRS configuration supporting codebook-based UL transmission for an 8TX UE,
Support configuration of 1 SRS resource set containing up to X 8-port SRS resource(s), where X=2
   FFS: Other values for X, if needed
FFS: Configuration of at least one SRS resource set, configured with more than one SRS resources where each SRS resource may have the same or different number of SRS ports, e.g., for support full power operation, if supported
FFS: Configuration of at least one SRS resource set, configured with 8/M of M-port SRS resources, for example,
   Configuration of an SRS resource set, configured with at least 4 of 2-port SRS resources
   Configuration of an SRS resource set, configured with at least 2 of 4-port SRS resources.

### 2.1.6 TCI States and QCL

A Transmission Configuration indication (TCI) state contains Quasi Co-location (QCL) information between the Demodulation Reference Signal (DMRS) of PDSCH and one or two DL reference signals (RS) such as a CSI-RS (Channel State Information Reference Signal) or a SSB (Synchronization Signal Block). Two antenna ports are said to be QCL if certain channel parameters associated with one of the two antenna ports can be inferred from the other antenna port.

The supported QCL information types in NR include:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

A list of TCI states can be RRC configured in a higher layer parameter PDSCH-Config information element (IE) (see 3gpp TS 38.331 section 6.3.2 for details), up to 8 TCI states from the list can be activated with a MAC CE. In NR Rel-15, one TCI state is activated by a MAC CE for each TCI codepoint of a TCI field in DCI, where up to 8 TCI codepoints can be supported (see 3gpp TS 38.321 section 6.1.3.14 for details). In NR Rel-16, up to two TCI states can be activated by a MAC CE for each TCI codepoint (see 3gpp TS38.321 section 6.1.3.24). For dynamically scheduled PDSCH, one of the TCI codepoints is indicated in the TCI field of the DCI (DCI format 1_1 or DCI format 1_2) scheduling the PDSCH for PDSCH reception. For example, if a SSB or CSI-RS is configured as the QCL-typeD source RS in an activated TCI state indicated to a PDSCH, the same receive beam for receiving the SSB or CSI-RS would be used by a UE to receive the PDSCH.

2.1.7 Beam Management with Unified TCI Framework

In NR, downlink beam management is performed by conveying spatial QCL (‘Type D’) assumptions to the UE through TCI states.

The NR Rel-15 and Rel-16 beam management framework allows great flexibility for the network to instruct the UE to receive signals from different spatial directions in DL with a cost of large signaling overhead and slow beam switch. These limitations are particularly noticeable and costly when UE movement is considered. One example is that beam update using DCI can only be performed for PDSCH, and MAC-CE and/or RRC is required to update the beam for other reference signals/channels, which introduces extra overhead and latency.

Furthermore, in the majority of cases, the network transmits to and receive from a UE in the same direction for both data and control. Hence, using separate framework (TCI state respective spatial relations) for different channels/signals complicates the implementations.

In Rel-17, a unified TCI state based beam indicated framework was introduced to simplify beam management in FR2 in which a common beam represented by a TCI state may be activated/indicated to a UE and the common beam is applicable for multiple channels/signals such as PDCCH and PDSCH. The common beam framework is also referred to a unified TCI state framework. A TCI state configured under the newly introduced Rel-17 framework will henceforth be referred to as a unified TCI state.

The new framework can be RRC configured in one out two modes of operation, i.e., “Joint DL/UL TCI” or “Separate DL/UL TCI”. For “Joint DL/UL TCI”, one common Joint TCI state is used for both DL and UL signals/channels. For “Separate DL/UL TCI”, one common DL-only TCI state is used for DL channels/signals and one common UL-only TCI state is used for UL signals/channels.

A unified TCI state for separate DL/UL or Joint DL/UL comprises identifiers of two QCL source reference signals as shown below, where the first RS is a QCL source RS for one of {typeA, typeB, typeC}QCL types, while the second RS is a QCL source RS for QCL typeD. The second RS is used to indicate a spatial beam or filter associated with the unified TCI state. An example ASN.1 code for configuring separate UL/DL or Joint DL/UL TCI state is shown below.

| DLorJoint-TCIState-r17 ::= | SEQUENCE { |
|---|---|
| tci-StateUnifiedId-r17 | DLorJoint- |
| TCIState-Id-r17, | |
| tci-StateType-r17 | ENUMERATED |
| {DLOnly, JointULDL}, | |
| qcl-Type1-r17 | QCL-Info, |
| qcl-Type2-r17 | QCL-Info |
| OPTIONAL -- Need R | |
| } | |
| QCL-Info ::= | SEQUENCE { |
| cell | ServCellIndex |
| OPTIONAL, -- Need R | |
| bwp-Id | BWP-Id |
| OPTIONAL, -- Cond CSI-RS-Indicated | |
| referenceSignal | CHOICE { |
| csi-rs | NZP-CSI-RS- |
| ResourceId, | |
| ssb | SSB-Index |
| }, | |
| qcl-Type | ENUMERATED {typeA, |

typeB, typeC, typeD},
...,

A unified TCI state can be updated in a similar way as the TCI state update for PDSCH in Rel-15/16, i.e., with one of two alternatives:
Two-stage: RRC signaling is used to configure a number of unified TCI states in higher layer parameter PDSCH-config, and a MAC-CE is used to activate one of the unified TCI states
Three-stage: RRC signaling is used to configure a number of unified TCI states in PDSCH-config, a MAC-CE is used to activate up to 8 unified TCI states, and a 3-bit TCI bitfield in DCI is used to indicate one of the activate unified TCI states

The one activated or indicated unified TCI state will be used in subsequent for both PDCCH and PDSCH transmissions until a new unified TCI state is activated or indicated.

The existing DCI formats 1_1 and 1_2 are used for unified TCI state of beam indication (i.e., TCI state indication/update), both with and without DL data assignment, i.e., PDSCH. For DCI formats 1_1 and 1_2 with DL assignment, ACK/NACK of the PDSCH can be used as indication of successful reception of beam indication. For DCI formats 1_1 and 1_2 without DL assignment, a new ACK/NACK mechanism analogous to that for SPS (semi-persistent scheduling) PDSCH release with both type-1 and type-2 HARQ-ACK codebook is used, where upon a successful reception of the beam indication DCI, the UE sends an HARQ-ACK.

### 2.1.8 DCI-Based Beam Indication

For DCI-based beam indication the first slot to apply the indicated TCI is at least Y symbols after the last symbol of the acknowledgment of the joint or separate DL/UL beam indication. The Y symbols are configured by the gNB based on UE capability, which is also reported in units of symbols.

### 2.1.9 UE Capability Value Set

To handle UE panels with different capabilities, it was agreed in Rel-17 to include UE panel specific capabilities in beam reports. In the first step, during UE capability signaling, the UE reports a list of “UE capability value sets”, where each “UE capability value set” comprises information about maximum number of supported SRS ports for the different UE panels. Each “UE capability value” is associated with a different capability (i.e., a different number of supported SRS ports). One or multiple UE panels are then associated to each “UE capability value set”.

For example, assume that a UE has 4 UE panels (P1, P2, P3 and P4), and where P1, P2 and P3 has two TX chains (i.e., can support maximum 2 SRS ports) and that P4 only has a single TX chain (i.e. only can support a single SRS port), then the UE would report two “UE capability value sets”, one “UE capability value set” that indicates a maximum of 2 supported SRS ports (which in this case is associated to UE panels P1, P2 and P3), and one “UE capability value set” that indicates a maximum of 1 supported SRS port (which in this case is associated with UE panel P4). Then, for each reported beam in a beam report, the UE could include a “UE capability value set”-index that indicates the “UE capability value set” that is associated with the UE panel used to receive the DL-RS associated with the reported beam. In this way, in addition to the Rel-15/16 performance metric (i.e., L1-RSRP or L1-SINR) included for each beam in a beam report, the gNB will also get information about the maximum number of UL layers associated with each reported beam.

Error! Reference source not found. illustrates a schematic example of a UE with two panels (P1 and P2), where P1 supports up to rank 2 UL transmission and P2 supports up to rank 1 UL transmission, and the corresponding reported “UE capability value sets”.

### 2.1.10 Group-Based Beam Reporting in NR

Simultaneous DL mTRP transmission with multi-panel reception can enable non-coherent joint-transmission (NC-JT) in FR2. An example is shown in Error! Reference source not found., where a PDSCH is sent to a UE over two TRPs, with each TRP transmitting 2 layers. In this case, by transmitting PDSCH over two TRPs to the UE, the peak data rate to the UE can be increased as up to 4 aggregated layers from the two TRPs can be received by the UE.

In NR Rel-15, when a UE is configured with higher layer parameter groupBasedBeamReporting set to ‘enabled’, the UE will report either two different CRIs or two different SSBRIs in a single reporting instance for each report setting. The two CRIs or two SSBRIs are chosen such that the corresponding CSI-RS and/or SSB resources can be received simultaneously by the UE.

Error! Reference source not found. shows an example scenario illustrating simultaneous DL mTRP transmission with multi-panel reception at the UE. In this example, NZP CSI-RS resources #1 and #2 are transmitted from TRP1 and NZP CSI-RS resources #3 and #4 are transmitted from TRP2. The UE is equipped with two panels.

In the above example, if the UE uses the existing group-based beam reporting in NR (i.e., when groupBasedBeamReporting is enabled), the UE may choose the two CRIs to be reported in one of the following ways:
Case 1: both CRIs correspond to TRP1 (e.g., NZP CSI-RS resources #1 and #2 are chosen by the UE)
Case 2: both CRIs correspond to TRP2 (e.g., NZP CSI-RS resources #3 and #4 are chosen by the UE)
Case 3: one of the CRIs corresponds to TRP and the other CRI corresponds to TRP2 (e.g., NZP CSI-RS resources #1 and #3 are chosen by the UE)

If UE reports the two CRIs according to either Case 1 or Case 2, then both beams reported correspond to the same TRP. In Cases 1 and 2, simultaneous multi-TRP transmission is not possible. Case 3 allows simultaneous multi-TRP transmission as the two beams reported correspond to different TRPs.

To handle this issue, group-based beam reporting was enhanced in Rel-17, where the UE can be configured to report in a single CSI-report N beam groups (where N is RRC configured and can be up to Nₘₐₓ, where Nₘₐₓ ∈{1, 2, 3, 4} is a UE capability), where each beam group consists of two beams (i.e. 2 SSBRI/CRI values and corresponding LT-RSRP), and where the two beams can be received simultaneously by the UE. To make sure that each beam in a beam group is associated to different TRPs, the UE can be configured with two channel measurement resource (CMR) sets, where each CMR set is associated to one TRP, and where the UE selects one CMR (i.e., one SSBRI/CRI) from each CMR set in each beam group. For periodic/semi-persistent CMRs, two CMR resource sets are configured per periodic/semi-persistent CMR resource setting. For aperiodic CMR, the existing RRC parameter CSI-AssociatedReportConfigInfo is extended to be configured with two CMR resource sets.

When gNB configures UE to report Rel-17 group-based beam reporting, the supported report format is shown in Table 2 [TS 38.212]. In the table, the 1-bit Resource set indicator, is used to indicate ifSthe strongest beam (i.e., CRI or SSBRI #1 of 1st resource group) belongs to the 1st or the 2nd CMR set. Absolute RSRP (7 bits) is reported for the strongest beam, and differential RSRP (4 bits) is reported for the remaining beams. The bit width of each SSBRI/CRI is determined based on the number of SSB/CSI-RS resources in the associated CMR resource set.

TABLE 2
Supported report format of Rel-17 group-based beam reporting

| CSI report number | CSI-fields |
|---|---|
| CSI report #n | Resource set indicator |
| | CRI or SSBRI #1 of 1st resource group |
| | CRI or SSBRI #2 of 1st resource group |
| | CRI or SSBRI #1 of 2nd resource group, if reported |
| | CRI or SSBRI #2 of 2nd resource group, if reported |
| | CRI or SSBRI #1 of 3rd resource group, if reported |
| | CRI or SSBRI #2 of 3rd resource group, if reported |
| | CRI or SSBRI #1 of 4th resource group, if reported |
| | CRI or SSBRI #2 of 4th resource group, if reported |
| | RSRP of CRI or SSBRI #1 of 1st resource group |
| | Differential RSRP of CRI or SSBRI #2 of 1st resource group |
| | Differential RSRP of CRI or SSBRI #1 of 2nd resource group, if reported |
| | Differential RSRP of CRI or SSBRI #2 of 2nd resource group, if reported |
| | Differential RSRP of CRI or SSBRI #1 of 3rd resource group, if reported |
| | Differential RSRP of CRI or SSBRI #2 of 3rd resource group, il reported |
| | Differential RSRP of CRI or SSBRI #1 of 4th resource group, if reported |
| | Differential RSRP of CRI or SSBRI #2 of 4th resource group, if reported |

3. Issues and Solutions with Embodiments of the Invention

There currently exist certain challenge(s). According to the agreements above, two SRS resource sets will be supported for STxMP PUSCH in NR Rel-18. Furthermore, up to two SRS resource sets for 8 TX CB-based and NCB-based operation may be supported in NR Rel-18.

An open question is how to configure precoding and number of layers for such multi SRS resource set operation. Furthermore, it is also an open question how to switch between transmission modes (e.g., sTRP, SDM, SFN).

Certain aspects of the disclosure and their embodiments may provide solutions to these or other challenges. For an UL transmission spanning the SRS ports associated with multiple SRS resource sets, the invention disclosure describes the following methods:
Methods for dynamically switching between, at least SDM and SFN transmission and, in some embodiment, Rel-17 mTRP PUSCH transmission by repurposing/extending existing SRS resource set indicator field in DCI.
Methods to indicate precoding and rank for SDM/SFN PUSCH over two SRS resource sets, including potential rank restrictions.
Methods to handle SRS transmission for STxMP for UEs with different number of Tx chains for different UE panels.

Certain embodiments may provide one or more of the following technical advantage(s). The proposed solution enables, in an overhead-efficient way, precoding/rank indication as well as dynamic switching between transmission modes (e.g., SDM and SFN) for an UL transmission occurring simultaneously over the SRS ports belonging to multiple SRS resource sets.

### 4. Exemplary Embodiments

In what follows, we shall assume that two SRS resource sets are configured for a DCI format (e.g., DCI format 0_1 or DCI format 0_2) for UL transmission. The use case can be either of STxMP and 8 Tx UL transmission:
For 8 Tx, an SRS resource set is associated with an “antenna-port group” (i.e., a subset of UE antenna ports within which antenna ports can be assumed to be coherent).
For STxMP, an SRS resource set is associated with a panel.

While these examples are given for illustration, embodiments of the inventions are not so limited (e.g., they are applicable to more than two SRS resource sets).

4.1 Repurposing/Extending Existing SRS Resource Set Indicator Field in DCI to Dynamically Switch Between, at Least, sTRP, SDM, and SFN Transmission

In one embodiment, the 2-bit SRS resource set indicator field in DCI, introduced in NR Rel-17 (see Section 0) is repurposed to indicate a number of SRS resource sets over which a same PUSCH transmission is to be transmitted at a single transmission and to dynamically switch between transmission modes (including for example sTRP, SDM, and SFN transmission). In contrast to legacy NR, where a same set of layers is transmitted over the SRS ports in each of the two SRS resource sets at different time instances (i.e., TDM), here different sets of layers can be transmitted at the same time (i.e., SDM (or FDM)) or the same set of layers are simultaneously transmitted over the SRS ports of both SRS resource sets (i.e., SFN).

Note that legacy SRS resource set indication field includes not only two codepoints for sTRP transmission (i.e., for PUSCH transmission associated with one of two SRS resource sets) but also two codepoints for mTRP transmission (i.e., for transmission associated with two SRS resource sets). The reason for having two mTRP transmission codepoints is to indicate the order in which the PUSCH are transmitted towards two TRPs each associated with one of the two SRS resource sets (see Section 0), which has importance in the mTRP PUSCH repetition scheme (i.e., in which order the TRPs receive PUSCH). For simultaneous PUSCH transmission towards two TRPs, no such ordering is needed.

In one embodiment, mTRP codepoints (e.g., codepoint 2 and 3) in the 2-bit SRS resource indicator field in DCI format 0_1 and/or 0_2 is used to indicate simultaneous transmission of PUSCH over the SRS ports belonging to two SRS resource sets. A first of said codepoints (e.g., codepoint 3 is used to indicate SDM PUSCH transmission for which a different set of layers are associated with each of the SRS resource sets. A second of said codepoints (e.g., codepoint 2) is used to indicate SFN transmission for which a same set of layers are associated with both SRS resource sets. An example of such a repurposed SRS resource set indicator field is presented in Table 3.

TABLE 3
Repurposed SRS resource set indicator field to
switch between sTRP, SDM, and SFN transmission.

| Bit field | |
|---|---|
| mapped | |
| to index | SRS resource set indication (for sTRP, SDM, or SFN) |
| 0 | SRS resource indicator field and Precoding information and |
| | number of layers field are associated with the first SRS |
| | resource set; |
| | Second SRS resource indicator field and Second Precoding |
| | information field are reserved. |
| 1 | SRS resource indicator field and Precoding information and |
| | number of layers field are associated with the second SRS |
| | resource set; |
| | Second SRS resource indicator field and Second Precoding |
| | information field are reserved. |
| 2 | SRS resource indicator field and Precoding information and |
| | number of layers field are associated with the first SRS |
| | resource set; |
| | Second SRS resource indicator field and Second Precoding |
| | information field are associated with the second SRS |
| | resource set. |
| 3 | SRS resource indicator field and Precoding information and |
| | number of layers field are associated with the first SRS |
| | resource set; |
| | Second SRS resource indicator field and Second Precoding |
| | information and number of layers field are associated with |
| | the second SRS resource set. |

Note:
For index 2, the same set of layers are associated with both SRS resource sets (e.g., SFN). For index 3, the total number of layers over the two SRS resource sets is the sum of the indicated number of layers across the two SRS resource indicator fields for NCB-based PUSCH and across the two Precoding information and number of layers fields for CB-based PUSCH (e.g., SDM).

In the above embodiment, the SRS resource set indicator field can be used solely for sTRP and simultaneous transmission. This implies, e.g., that switching between Rel-17 mTRP repetition and STxMP needs to be configured by RRC (i.e., UE needs to know a priori how to interpret the SRS resource set indicator field). For STxMP, according to agreements above, dynamic switching between Rel-17 mTRP PUSCH repetition and Rel-18 STxMP PUSCH is for future study.

In another embodiment, the interpretation of codepoints 2 and 3 depends on whether a number of PUSCH repetitions is configured by RRC or indicated in the same DCI (e.g., in the time domain resource allocation (TDRA) field). If two or more PUSCH repetitions are RRC configured or dynamically indicated in the DCI, the two codepoints would be interpreted based on legacy NR Rel-17 mTRP PUSCH repetition. Otherwise, the two codepoints are interpreted for STxMP, i.e., one codepoint indicates SDM transmission while the other codepoint indicates SFN transmission.

In another embodiment, dynamic switching between Rel-17 mTRP repetition and Rel-18 STxMP is supported over DCI by extending the 2-bit SRS resource set indicator field (e.g., to 3 bits) to include SDM STxMP and SFN STxMP codepoints in addition to Rel-17 mTRP (and sTRP) repetition codepoints. An example is shown in Table 4.

TABLE 4
Repurposed SRS resource set indicator field to switch
between Rel-17 sTRP repetition, Rel-17 mTRP repetition,
SDM STxMP, and SFN STxMP transmission.

| Bit field | |
|---|---|
| mapped | SRS resource set indication (for sTRP, mTRP repetition, |
| to index | SDM, or SFN) |
| 0 | SRS resource indicator field and Precoding information |
| | and number of layers field are associated with the first |
| | SRS resource set; |
| | Second SRS resource indicator field and Second |
| | Precoding information field are reserved. |
| 1 | SRS resource indicator field and Precoding information |
| | and number of layers field are associated with the |
| | second SRS resource set; |
| | Second SRS resource indicator field and Second |
| | Precoding information field are reserved. |
| 2 | SRS resource indicator field and Precoding information |
| | and number of layers field are associated with the first |
| | SRS resource set; |
| | Second SRS resource indicator field and Second |
| | Precoding information field are associated with the |
| | second SRS resource set. |
| 3 | SRS resource indicator field and Precoding information |
| | and number of layers field are associated with the first |
| | SRS resource set; |
| | Second SRS resource indicator field and Second |
| | Precoding information field are associated with the |
| | second SRS resource set. |
| 4 | SRS resource indicator field and Precoding information |
| | and number of layers field are associated with the first |
| | SRS resource set; |
| | Second SRS resource indicator field and Second |
| | Precoding information field are associated with the |
| | second SRS resource set. |
| 5 | SRS resource indicator field and Precoding information |
| | and number of layers field are associated with the first |
| | SRS resource set; |
| | Second SRS resource indicator field and Second |
| | Precoding information and number of layers field are |
| | associated with the second SRS resource set. |
| 6-7 | Reserved |

Note:
The difference between indices 2-3 and 4-5 is that SRS resources are transmitted in separate slots (over K slots) for indices 2-3 whereas SRS resources are transmitted at the same time in one slot (if repetition is not indicated) or multiple slots (if repetition is configured) for indices 4-5.
Note:
For index 4, the same set of layers are associated with both SRS resource sets. For index 5, the total number of layers over the two SRS resource sets is the sum of the indicated number of layers per SRS resource set.

In the above embodiment the indication of the SRS resource indicator field and Precoding information and number of layers field is associated to one or both of a first SRS resource set and a second SRS resource set. For the Rel-15/16 TCI state framework, the spatial filter to be used for the PUSCH transmission associated with the first SRS resource set will be based on the spatial filter associated with the first SRS resource set, and the spatial filter to be used for the PUSCH transmission associated with the second SRS resource set will be based on the spatial filter associated with the second SRS resource set. However, for the unified TCI state framework specified in Rel-18 and that will be extended to multi-TRP operation in Rel-18, it is still not decided if the spatial filter for the PUSCH will be directly associated to one out of two activated Joint/UL TCI states or be based on the spatial filter of the associated SRS transmission (as in Rel-15/16 TCI state framework). Hence, in one embodiment, the previous embodiments as described in section 4.1 is updated to also indicate association to one or both of two activated Joint/UL TCI states (which should be applied when the UE is configured with unified TCI state framework instead of Rel-15/16 TCI state framework for PUSCH). One example can be seen in the Table 12 below, where the added text is marked in yellow color. The text in the yellow color basically indicates that the UE should determine the spatial filter of the PUSCH transmission based on one or both of the activated Joint/UL TCI states, regardless of which spatial filter that was used for the associated SRS transmission.

In one embodiment, similar extension is made to Table 11 above.

TABLE 5
Repurposed SRS resource set indicator field to switch between sTRP,
SDM, and SFN transmission for unified TCI state framework.

| Bit field | |
|---|---|
| mapped | |
| to index | SRS resource set indication (for sTRP, SDM, or SFN) |
| 0 | SRS resource indicator field and Precoding information and |
| | number of layers field are associated with the first SRS |
| | resource set and are associated with a first activated |
| | Joint/UL TCI state; |
| | Second SRS resource indicator field and Second Precoding |
| | information field are reserved. |
| 1 | SRS resource indicator field and Precoding information and |
| | number of layers field are associated with the second SRS |
| | resource set and are associated with a second activated |
| | Joint/UL TCI state; |
| | Second SRS resource indicator field and Second Precoding |
| | information field are reserved. |
| 2 | SRS resource indicator field and Precoding information and |
| | number of layers field are associated with the first SRS |
| | resource set and are associated with a first activated |
| | Joint/UL TCI state; |
| | Second SRS resource indicator field and Second Precoding |
| | information field are associated with the second SRS |
| | resource set and are associated with a second activated |
| | Joint/UL TCI state. |
| 3 | SRS resource indicator field and Precoding information and |
| | number of layers field are associated with the first SRS |
| | resource set and are associated with a first activated |
| | Joint/UL TCI state; |
| | Second SRS resource indicator field and Second Precoding |
| | information and number of layers field are associated with |
| | the second SRS resource set and are associated with a |
| | second activated Joint/UL TCI state. |

Note:
For index 2, the same set of layers are associated with both SRS resource sets. For index 3, the total number of layers over the two SRS resource sets is the sum of the indicated number of layers across the two SRS resource indicator fields for NCB-based PUSCH and across the two Precoding information and number of layers fields for CB-based PUSCH.

### 4.2 Embodiments Related to Indicating Number of Layers Per SRS Resource Set

For STxMP, it has been agreed that two SRS resource sets will be supported, at least, for SDM. Whether 1 or 2 SRS resource sets will be supported for SFN is not decided. Furthermore, it is still up for discussion whether UE will indicate support for a maximum number of layers separately for each panel or if a maximum number of layers over both panels will be indicated.

4.2.1 SFN Transmission for STxMP and/or 8 Tx PUSCH

In one embodiment, for SFN transmission and if the UE has indicated support for a maximum of L_{max,1} layers over the first SRS resource set and L_{max,2} layers over the second SRS resource set, then the maximum number of layers for SFN transmission is min{L_{max,1}, L_{max,2}) and
For CB-based transmission, the size/entries of the Precoding Information and Number of Layers field in DCI will determined based on this number.
For NCB-based transmission, the maximum number of SRS resources that can be indicated by the SRS resource indicator field is min{L_{max,1}, L_{max,2}}.

In another embodiment, for SFN PUSCH transmission with R (R is an integer) layers, R layers are indicated in each of the two precoding information and number of layers fields for CB based PUSCH or in each of the two SRS resource indicator fields for non-CB based PUSCH. Note that this embodiment assumes that there a first and a second precoding Information and Number of Layers fields in DCI, which is in contrast to examples in Section 4.1 where there is one Precoding Information and Number of Layers field and one Second Precoding Information field.

In a further embodiment, for SFN PUSCH transmission, the number of layers is indicated in only one of the two precoding information and number of layers fields for CB-based PUSCH or in one of the two SRS resource indicator fields for non-CB based PUSCH (i.e., as in examples provided in Section 4.1).

4.2.2 SDM Transmission for STxMP and/or 8 Tx

### 4.2.2.1 First and Second SRS Resource Indication (SRI) Field

The below embodiments are for NCB-based precoding.

In one embodiment, the number of layers over the second SRS resource indicator field can be different from the number of layers over the first SRS resource indicator field but does not depend on the number of layers over the first SRS resource indicator field.

In one example of this embodiment, if Lₘₐₓ layers are supported by the UE and Lₘₐₓ/2 layers are supported over either of the panels, then the number of SRS resources that can be indicated using either of the two SRS resource indicator field is Lₘₐₓ/2 if Lₘₐₓ is even. If Lₘₐₓ is odd, then ┌Lₘₐₓ/2┐ SRS resources can be indicated over a first SRS resource set and ┘Lₘₐₓ/2└ SRS resources can be indicated over a second SRS resource set. In one embodiment, ┌Lₘₐₓ/2┐ SRS resources can be indicated over the SRS resource set with the lower SRS resource set index.

In another embodiment, if sTRP transmission is indicated (i.e., if only one SRS resource set is indicated) using the SRS resource set indicator field (see Section 4.1), then the network does not indicate a number of layers for the non-indicated SRS resource set. In other words, there is only one SRS resource indicator (SRI) field in DCI.

In one example of this another embodiment, if Lₘₐₓ layers are supported by the UE and Lₘₐₓ layers are supported over either of the panels, then the number of SRS resources that can be indicated using the single SRS resource indicator field is Lₘₐₓ. For example, if the maximum rank is 4 and the UE is transmitting using only one panel, then the maximum number of layers over that panel is 4 (i.e., layer combinations 0+4 and 4+0 are supported).

In one embodiment, the UE can be configured with two maximum values of layers for each panel, given by L_{max,1} and L_{max,2}, respectively. Then the maximum number of SRS resources that can be indicated by the first and second SRS resource indicator field is L_{max,1} and L_{max,2}, respectively.

### 4.2.2.2 First and Second Transmit Precoder Matrix Indicator (TPMI) Fields

The below embodiments are for CB-based precoding.

In one embodiment, the number of layers over the second precoding information and number of layers field can be different from the number of layers over the first SRS resource indicator field but does not depend on the number of layers over the first SRS resource indicator field.

In one example of this embodiment, if Lₘₐₓ layers are supported by the UE and Lₘₐₓ/2 layers are supported over either of the panels, then the number of layers that can be indicated using either of the precoding information and number of layers field is Lₘₐₓ/2 if Lₘₐₓ is even. If Lₘₐₓ is odd, then ┌Lₘₐₓ/2┐ layers can be indicated over a first SRS resource set and ┘Lₘₐₓ/2└ layers can be indicated over a second SRS resource set. In one embodiment, ┌Lₘₐₓ/2┐ layers can be indicated over the SRS resource set with the lower SRS resource set index.

In another embodiment, if sTRP transmission is indicated (i.e., if only one SRS resource set is indicated) using the SRS resource set indicator field (see Section 4.1), then the network does not indicate a number of layers for the non-indicated SRS resource set. In other words, there is only one precoding information and number of layers field in DCI.

In one example of this another embodiment, if Lₘₐₓ layers are supported by the UE and Lₘₐₓ layers are supported over either of the panels, then the number of layers that can be indicated using the single precoding information and number of layers field is Lₘₐₓ. For example, if the maximum rank is 4 and the UE is transmitting using only one panel, then the maximum number of layers over that panel is 4 (i.e., layer combinations 0+4 and 4+0 are supported).

In one embodiment, the UE can be configured with two maximum values of layers for each panel, given by L_{max,1} and L_{max,2}, respectively. Then the maximum number of layers that can be indicated by the first and second precoding information and number of layers field is L_{max,1} and L_{max,2}, respectively.

4.3 STxMP for UEs with Different Number of TX Ports for Different UE Panels

Some UEs are equipped with multiple UE panels and where different UE panels support different number of UL layers. For example, a UE can be equipped with 4 UE panels, and where two UE panels support maximum 1 UL layer (i.e., have one TX chain) and two UE panels supports maximum 2 UL layers (i.e., have two TX chains). In this case, one issue is how many SRS ports the two SRS resource sets should be configured with and how the UE should handle the SRS transmission depending on which UE panel that it used for a certain SRS transmission. For example, in case the UE wants to use a UE panel with one TX chain, but the associated SRS resource set is configured with two SRS ports, how the UE should handle the SRS transmission is an open issue.

In one embodiment, the group-based beam reporting specified in Rel-17 is extended to include a UE capability value set index for each reported beam. In one embodiment, the group-based beam reporting specified in Rel-17 is extended with a UE capability value set index for each of the two beams in the first beam group (i.e., the beam group containing the strongest beam), in order to save reporting overhead. By including the UE capability value set index in the group-based beam report, when the network triggers SRS transmission for coming STxMP, the network will know how many SRS ports that will be required for each of the two SRS resource sets.

In one embodiment, the two SRS resource sets are configured with as many SRS ports as the maximum number of SRS ports supported by any of the UE panels, up to maximum 2 SRS ports per SRS resource sets. So, for example, if a UE supports maximum one UL layers on all UE panels, then both SRS resource sets are configured with a single SRS port. However, in case one of the UE panels supports up to 2 UL layers, then both SRS resource sets should be configured with 2 SRS ports.

In one embodiment, when a UE is triggered to transmit an SRS resource set with two SRS ports on a UE panel with one TX chain (i.e., when the UE panel is associated with a UE capability value set supporting maximum one SRS port), the UE transmits both SRS ports on the same TX chain. One drawback with this solution is that unnecessary SRS overhead and transmission power is used by the UE. Hence, in one embodiment, when the UE is triggered with an SRS resource set with two SRS ports to be transmitted on a UE panel with one TX chain, the UE should blank (drop) the transmission of one SRS port. In one embodiment, the UE should blank (drop) the SRS port with highest SRS port index. In another embodiment the UE should blank (drop) the SRS port with lowest SRS port index. In one embodiment, when the UE blank (drop) one out of two SRS ports of an SRS resource set, the UE applies all the power on the single SRS ports that is transmitted (hence this SRS port will be transmitted with twice the power compared to if both SRS ports were transmitted). In one embodiment, the UE use the same transmission power for the single SRS port as it would have used in case it transmitted two SRS ports.

It is possible that the maximum rank for STxMP per UE panel is equal to 2, which most likely will mean that each of the two SRS resource sets used for STxMP will be configured with 2 SRS ports. However, it is possible that when the UE is triggered for single-TRP UL transmission (for example when a single joint/UL TCI state is selected/indicated/applied), the maximum number of layers is equal to 4. However, since each SRS resource set contains 2 SRS ports, using only one of the SRS resource sets during single-TRP operation will limit the rank also for single TRP operation (and RRC re-configure the number of SRS ports in an SRS resource set is cumbersome due to overhead and latency with RRC signaling). To solve this several candidate solutions are possible:

For example: In one embodiment the UE is configured with a third SRS resource set with usage CB or NCB, where the number of SRS ports in that SRS resource set can be larger than 2, and when the UE is scheduled for single TRP operation (e.g., when a single joint/UL TCI state is selected), the UE should use this third SRS resource set instead of the other two that are used for STxMP. In one embodiment, the third SRS resource set is de-activated when two joint/UL TCI states are indicated/applied/selected (i.e., for multi-TRP UL transmission), and becomes activated when single joint/UL TCI states are indicated/applied/selected (i.e., for single-TRP UL transmission). In one embodiment, the two SRS resource sets for STxMP, becomes de-activated when a single joint/UL TCI state are indicated/applied/selected (i.e., single-TRP operation UL transmission is applied) and they become activated when two joint/UL TCI states are indicated/applied/selected (i.e., for multi-TRP UL transmission). In one embodiment, a new parameter or flag is introduced in an SRS resource set IE (as specified in TS 38.331), where the parameter or flag is used to indicate if the SRS resource set should be used during single TRP UL transmission and/or multi-TRP UL transmission.

For another example: In one embodiment, when the UE is scheduled for single TRP operation (e.g., when a single joint/UL TCI state is selected), the UE should concatenate the two SRS resource sets for STxMP to a single “virtual SRS resource set”. So for example assume that for STxMP there are a first SRS resource set with two ports and a second SRS resource set with 2 ports, then during single TRP operation, the UE concatenates these two SRS resource sets to a new “virtual SRS resource set”, where ethe total number of SRS ports in the new “virtual SRS resource set” becomes 4 (please note that no actual SRS resource set is generated, the virtual SRS resource set just means that the SRS ports from two different SRS resource set are used to determine all the SRS ports for a single PUSCH transmission, where a single TPMI or SRI is used to indicate the precoder and rank for that PUSCH transmission). In one embodiment, the SRS ports of the SRS resource set with lowest SRS resource set index is counted as SRS ports with lowest index in the virtual SRS resource set. For example, assume SRS resource set 1 with SRS resource set ID 1, has one SRS resource with two SRS ports, and SRS resource set 2 with SRS resource set ID 2 also has one SRS resource with two SRS ports, then the virtual SRS resource set (to be used to sound the antennas for single TRP operation), will consist of four SRS ports, where SRS port 1 and SRS port 2 of the virtual SRS resource set comes from the SRS resource in the SRS resource set 1, and SRS Port 3 and SRS port 4 comes form the SRS resources in the SRS resource set 2. In another embodiment, the SRS ports in the virtual SRS resource set depends on the SRS resource ID of the SRS resources in both SRS resource sets (i.e. the SRS ports in the SRS resource with lowest SRS resource ID in any of the two SRS resource sets will have the lowest numbered SRS ports in the virtual SRS resource set, and the SRS ports in the SRS resource with highest SRS resource ID among the SRS resource s in the two SRS resource sets will have the highest SRS port numbers in the virtual SRS resource set).

### 5. Operation Flows

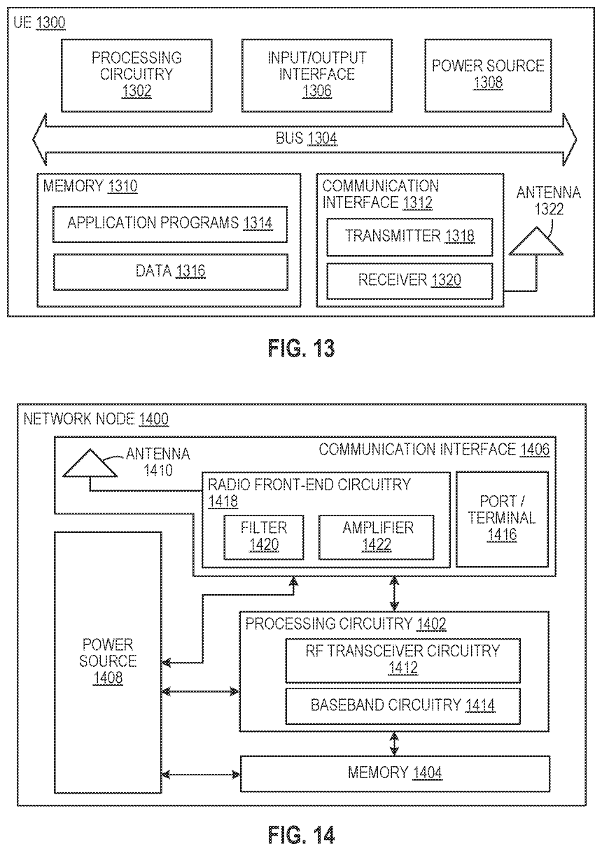

As discussed herein, the operations of the embodiments are performed between a network node (e.g., a base station such as a gNB or eNB, or another type of network node) and a UE in some embodiments. FIG. 8 illustrates a network node and a UE that perform uplink communication coordination per some embodiments. A network node 802 is a base station such as a gNB or eNB, or another type of network node (e.g., see FIG. 14), and a UE 804 is a wireless device discussed herein (e.g., see FIG. 13).

In some embodiments, the network node 802 issues uplink grants through a DCI at reference 852. The DCI may be used to configure SRS resources and SRS resource sets. In the DCI, embodiments of the invention set and construe one or more of (1) the SRS resource set indicator field(s), (2) the SRI field(s), and (3) TPMI field(s) differently from prior art as shown at reference 850. At reference 854, the UE transmits on a PUSCH using the PUSCH transmission scheme as indicated in the DCI message. The corresponding SRS is transmitted on the PUSCH using the PUSCH transmission scheme as indicated in the DCI message in some embodiments.

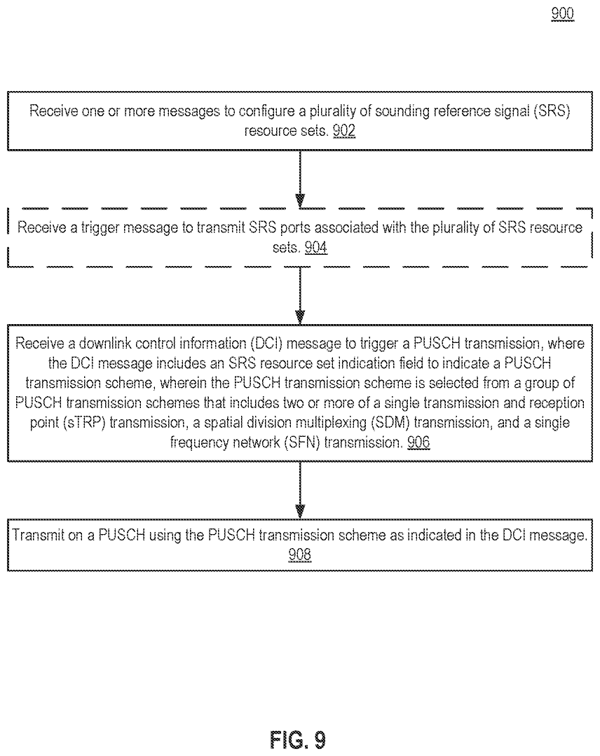

FIG. 9 illustrates the operations of a UE for transmitting on a Physical Uplink Shared Channel (PUSCH) simultaneously from one or more UE panels. The method includes a UE receiving one or more messages to configure a plurality of sounding reference signal (SRS) resource sets at reference 902. Optionally, the UE receives a trigger message to indicate one or more transmitting SRS ports associated with the plurality of SRS resource sets. Then at reference 906, the method continues with receiving a downlink control information (DCI) message to trigger a PUSCH transmission, where the DCI message includes a SRS resource set indication field to indicate a PUSCH transmission scheme, wherein the PUSCH transmission scheme is selected from a group of PUSCH transmission schemes that includes two or more of a single transmission and reception point (sTRP) transmission, a spatial division multiplexing (SDM) transmission, and a single frequency network (SFN) transmission. At reference 908, the UE transmits the PUSCH using the PUSCH transmission scheme as indicated in the DCI message.

In some embodiments, the SRS resource set indication field comprises two bits, and two out of four indices indicated through the two bits are interpreted as representing types of simultaneous multi-panel transmission (STxMP) schemes. Table 10 shows an example of codepoint mapping to the schemes.

In some embodiments, the two bits being interpreted as representing types of simultaneous PUSCH transmission schemes is based on the UE is Radio Resource Control (RRC) configured with the simultaneous PUSCH transmission schemes.

In some embodiments, the two bits are interpreted as representing a PUSCH transmission scheme when no more than one PUSCH repetition is configured.

In some embodiments, the PUSCH transmission scheme indicated in the SRS resource set field is the SFN transmission associated with both a first SRS resource set and a second SRS resource set within the plurality of SRS resource sets, wherein each of the first and second SRS resource sets is associated with the same set of uplink layers.

In some embodiments, the PUSCH transmission scheme indicated in the SRS resource set field is the SDM transmission associated with both a first SRS resource set and a second SRS resource set within the plurality of SRS resource sets. In some embodiments, each of the first and second SRS resource sets is associated with a different set of uplink layers.

In some embodiments, where one codepoint of the SRS resource set indication field indicates the PUSCH scheme being: the sTRP transmission associated with a first SRS resource set and that the PUSCH sTRP transmission is associated with a first activated joint/uplink Transmission Configuration indication (TCI) states, the sTRP transmission associated with a second SRS resource set and that the sTRP transmission is associated with a second activated joint/uplink TCI state, or the SDM transmission associated with a first and a second SRS resource set and that the SDM transmission is associated with a first and a second activated joint/uplink TCI state.

In some embodiments, where one codepoint of the SRS resource set indication field indicates the PUSCH transmission scheme being: the sTRP transmission associated with a first SRS resource set and that the sTRP transmission is associated with a first activated joint/uplink TCI state, the sTRP transmission associated with a second SRS resource set and that the sTRP transmission is associated with a second activated joint/uplink TCI state, or the SFN transmission associated with a first and a second SRS resource set and that the SFN transmission is associated with a first and a second activated joint/uplink TCI state.

In some embodiments, the DCI message includes two precoding information and number of layers fields, the size of which depends on the configured maximum of L_(max,1) layers over a first SRS resource set and L_(max,2) layers over a second SRS resource set for codebook (CB)-based transmission, both of the first and second SRS resource sets are within the plurality of SRS resource sets.

In some embodiments, the DCI message includes two SRS resource indicator fields, and the maximum number of SRS resources that can be indicated by the SRS resource indicator field is the minimum of the configured maximum of L_(max,1) layers over a first SRS resource set and L_(max,2) layers over a second SRS resource set, both of the first and second SRS resource sets are within the plurality of SRS resource sets for non-codebook (NCB)-based transmission.

In some embodiments, the DCI message includes two precoding information and number of layers fields, the size of which depends on the configured maximum number of Lₘₐₓ/2 layers over one or more of a first and second SRS resource set, both of the first and second SRS resource set are within the plurality of SRS resource sets for codebook (CB)-based transmission, and Lₘₐₓ is the maximum number of layers supported by the UE.

In some embodiments, the DCI message includes two precoding information and number of layers fields, the size of which depends on the configured maximum number of L_max layers over one of a first or second SRS resource set, both of the first and second SRS resource set are within the plurality of SRS resource sets for codebook (CB)-based transmission, and L_max is the maximum number of layers supported by the UE.

In some embodiments, wherein the DCI message includes two SRS resource indicator fields, and the maximum number of SRS resources that can be indicated by an SRS resource indicator field is Lₘₐₓ/2 layers over one or more of a first and second SRS resource set, both of the first and second SRS resource set are within the plurality of SRS resource sets for non-codebook (NCB)-based transmission, and Lₘₐₓ is the maximum number of layers supported by the UE.

In some embodiments, wherein the DCI message includes two SRS resource indicator fields, and the maximum number of SRS resources that can be indicated by an SRS resource indicator field is Lₘₐₓ layers over one of a first or second SRS resource set, both of the first and second SRS resource set are within the plurality of SRS resource sets for non-codebook (NCB)-based transmission, and Lₘₐₓ is the maximum number of layers supported by the UE.

In some embodiments, different UE panels of the UE support different maximum number of uplink layers or SRS ports, wherein the UE indicates in a group-based beam report per reported beam, the maximum supported number of layers or maximum supported SRS ports of a UE panel associated with that reported beam, and wherein the UE reports the maximum number of supported uplink layers or maximum number of supported SRS ports per UE panel by indicating a UE capability value set index per beam in the group-based beam report.

In some embodiments, when the UE transmits through SRS ports from a first SRS resource set configured with two SRS ports from a UE panel that supports maximum one SRS ports, the UE drops transmission of one of the two SRS ports, wherein the UE drops one of the two SRS ports based on comparison of the corresponding SRS port indices, and wherein the UE applies power on the remaining port that was applied on both of the two SRS ports.

In some embodiments, the plurality of SRS resource sets includes a first, a second, and a third SRS resource sets, wherein when the first and second SRS resource sets are used for simultaneous multi-panel transmission (STxMP), the third SRS resource set is deactivated, and wherein when the third SRS resource set is used for a sTRP transmission, the first and second SRS resource sets are deactivated, and wherein an SRS resource set information element indicates whether STxMP or sTRP transmission should be activated.

In some embodiments, the SRS resource set indication field comprises three bits indicating eight possible permutations, at least two of which are interpreted as representing single sTRP transmission schemes. In some embodiments, at least four of the eight possible permutations are to indicate STxMP schemes.

In some embodiments, the SRS resource set indication field comprises two bits that indicate one or both of two activated Joint/uplink Transmission Configuration indication (TCI) states, wherein one codepoint formed by the two bits a first SRS resource set (including TPMI and/or SRI) and a Joint/UL TCI state.

In some embodiments, one codepoint of the SRS resource set indication field indicates PUSCH sTRP transmission associated with a first SRS resource set and that the PUSCH sTRP transmission should be associated with a first activated Joint/uplink Transmission Configuration indication (TCI) states.

In some embodiments, one codepoint of the SRS resource set indication field indicates the PUSCH transmission scheme being the sTRP transmission associated with a second SRS resource set and that the sTRP transmission is associated with a second activated Joint/uplink TCI state.

In some embodiments, one codepoint of the SRS resource set indication field indicates the PUSCH transmission scheme being the SDM transmission associated with a first and a second SRS resource set and that the SDM transmission is associated with a first and a second activated Joint/uplink TCI state.

In some embodiments, one codepoint of the SRS resource set indication field indicates the PUSCH transmission scheme being the SFN transmission associated with a first and a second SRS resource set and that the PUSCH SFN transmission is associated with a first and a second activated Joint/uplink TCI state.

In some embodiments, the DCI message includes two precoding information and number of layers fields, and the size of which depends on the configured maximum of L_{max,1} layers over a first SRS resource set and L_{max,2} layers over a second SRS resource set for codebook (CB)-based transmission, both of the first and second SRS resource sets are within the plurality of SRS resource sets.

In some embodiments, the DCI message includes a SRS resource indicator field, and the maximum number of SRS resources that can be indicated by the SRS resource indicator field is the minimum of the configured maximum of L_{max,1} layers over a first SRS resource set and L_{max,2} layers over a second SRS resource set, both of the first and second SRS resource sets are within the plurality of SRS resource sets for non-codebook (NCB)-based transmission.

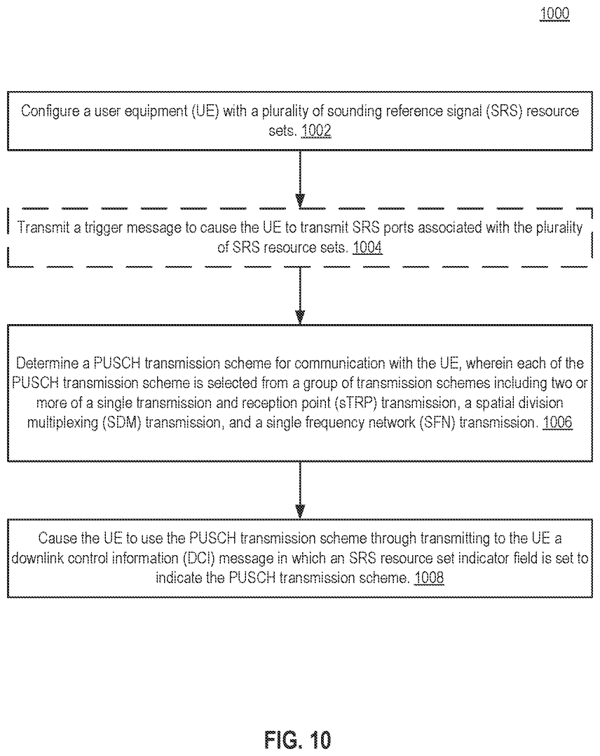

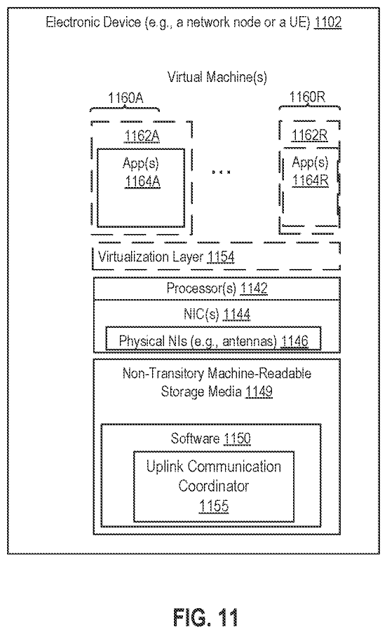

FIG. 10 illustrates operations of a network node for transmitting a Physical Uplink Shared Channel (PUSCH) simultaneously from one or more UE panels per some embodiments.

The method includes that the base station configures a user equipment (UE) with a plurality of sounding reference signal (SRS) resource sets at reference 1002. Optionally the method further includes that the base station transmits a trigger message to cause the UE to transmit SRS ports associated with the plurality of SRS resource sets at reference 1004. The method also includes that the base station determines a PUSCH transmission scheme for communication with the UE, wherein each of the PUSCH transmission scheme is selected from a group of transmission schemes including two or more of a single transmission and reception point (sTRP) transmission, a spatial division multiplexing (SDM) transmission, and a single frequency network (SFN) transmission at reference 1006. Then at reference 1008, the base station causes the UE to use the PUSCH transmission scheme through transmitting to the UE a downlink control information (DCI) message in which an SRS resource set indicator field is set to indicate the PUSCH transmission scheme.

In some embodiments, the SRS resource set indication field comprises two bits, and two out of four indices indicated through the two bits are interpreted as representing types of simultaneous multi-panel transmission (STxMP) schemes. Table 10 shows an example of codepoint mapping to the schemes.

In some embodiments, the two bits being interpreted as representing types of simultaneous PUSCH transmission schemes is based on the UE is Radio Resource Control (RRC) configured with the simultaneous PUSCH transmission schemes.

In some embodiments, the two bits are interpreted as representing a PUSCH transmission scheme when no more than one PUSCH repetition is configured.

In some embodiments, the PUSCH transmission scheme indicated in the SRS resource set field is the SFN transmission associated with both a first SRS resource set and a second SRS resource set within the plurality of SRS resource sets, wherein each of the first and second SRS resource sets is associated with the same set of uplink layers.

In some embodiments, the PUSCH transmission scheme indicated in the SRS resource set field is the SDM transmission associated with both a first SRS resource set and a second SRS resource set within the plurality of SRS resource sets. In some embodiments, each of the first and second SRS resource sets is associated with a different set of uplink layers.

In some embodiments, where one codepoint of the SRS resource set indication field indicates the PUSCH scheme being: the sTRP transmission associated with a first SRS resource set and that the PUSCH sTRP transmission is associated with a first activated joint/uplink Transmission Configuration indication (TCI) states, the sTRP transmission associated with a second SRS resource set and that the sTRP transmission is associated with a second activated joint/uplink TCI state, or the SDM transmission associated with a first and a second SRS resource set and that the SDM transmission is associated with a first and a second activated joint/uplink TCI state.

In some embodiments, where one codepoint of the SRS resource set indication field indicates the PUSCH transmission scheme being: the sTRP transmission associated with a first SRS resource set and that the sTRP transmission is associated with a first activated joint/uplink TCI state, the sTRP transmission associated with a second SRS resource set and that the sTRP transmission is associated with a second activated joint/uplink TCI state, or the SFN transmission associated with a first and a second SRS resource set and that the SFN transmission is associated with a first and a second activated joint/uplink TCI state.

In some embodiments, the DCI message includes two precoding information and number of layers fields, the size of which depends on the configured maximum of L_(max,1) layers over a first SRS resource set and L_(max,2) layers over a second SRS resource set for codebook (CB)-based transmission, both of the first and second SRS resource sets are within the plurality of SRS resource sets.

In some embodiments, the DCI message includes two SRS resource indicator fields, and the maximum number of SRS resources that can be indicated by the SRS resource indicator field is the minimum of the configured maximum of L_(max,1) layers over a first SRS resource set and L_(max,2) layers over a second SRS resource set, both of the first and second SRS resource sets are within the plurality of SRS resource sets for non-codebook (NCB)-based transmission.

In some embodiments, the DCI message includes two precoding information and number of layers fields, the size of which depends on the configured maximum number of Lₘₐₓ/2 layers over one or more of a first and second SRS resource set, both of the first and second SRS resource set are within the plurality of SRS resource sets for codebook (CB)-based transmission, and Lₘₐₓ is the maximum number of layers supported by the UE.

In some embodiments, the DCI message includes two precoding information and number of layers fields, the size of which depends on the configured maximum number of L_max layers over one of a first or second SRS resource set, both of the first and second SRS resource set are within the plurality of SRS resource sets for codebook (CB)-based transmission, and L_max is the maximum number of layers supported by the UE.

In some embodiments, wherein the DCI message includes two SRS resource indicator fields, and the maximum number of SRS resources that can be indicated by an SRS resource indicator field is Lₘₐₓ/2 layers over one or more of a first and second SRS resource set, both of the first and second SRS resource set are within the plurality of SRS resource sets for non-codebook (NCB)-based transmission, and Lₘₐₓ is the maximum number of layers supported by the UE.

In some embodiments, wherein the DCI message includes two SRS resource indicator fields, and the maximum number of SRS resources that can be indicated by an SRS resource indicator field is Lₘₐₓ layers over one of a first or second SRS resource set, both of the first and second SRS resource set are within the plurality of SRS resource sets for non-codebook (NCB)-based transmission, and Lₘₐₓ is the maximum number of layers supported by the UE.

In some embodiments, different UE panels of the UE support different maximum number of uplink layers or SRS ports, wherein the UE indicates in a group-based beam report per reported beam, the maximum supported number of layers or maximum supported SRS ports of a UE panel associated with that reported beam, and wherein the UE reports the maximum number of supported uplink layers or maximum number of supported SRS ports per UE panel by indicating a UE capability value set index per beam in the group-based beam report.

In some embodiments, when the UE transmits through SRS ports from a first SRS resource set configured with two SRS ports from a UE panel that supports maximum one SRS ports, the UE drops transmission of one of the two SRS ports, wherein the UE drops one of the two SRS ports based on comparison of the corresponding SRS port indices, and wherein the UE applies power on the remaining port that was applied on both of the two SRS ports.

In some embodiments, the plurality of SRS resource sets includes a first, a second, and a third SRS resource sets, wherein when the first and second SRS resource sets are used for simultaneous multi-panel transmission (STxMP), the third SRS resource set is deactivated, and wherein when the third SRS resource set is used for a sTRP transmission, the first and second SRS resource sets are deactivated, and wherein an SRS resource set information element indicates whether STxMP or sTRP transmission should be activated.

In some embodiments, the SRS resource set indication field comprises three bits indicating eight possible permutations, at least two of which are interpreted as representing single sTRP transmission schemes. In some embodiments, at least four of the eight possible permutations are to indicate STxMP schemes.

In some embodiments, the SRS resource set indication field comprises two bits that indicate one or both of two activated Joint/uplink Transmission Configuration indication (TCI) states, wherein one codepoint formed by the two bits a first SRS resource set (including TPMI and/or SRI) and a Joint/UL TCI state.

In some embodiments, one codepoint of the SRS resource set indication field indicates PUSCH sTRP transmission associated with a first SRS resource set and that the PUSCH sTRP transmission should be associated with a first activated Joint/uplink Transmission Configuration indication (TCI) states.

In some embodiments, one codepoint of the SRS resource set indication field indicates the PUSCH transmission scheme being the sTRP transmission associated with a second SRS resource set and that the sTRP transmission is associated with a second activated Joint/uplink TCI state.

In some embodiments, one codepoint of the SRS resource set indication field indicates the PUSCH transmission scheme being the SDM transmission associated with a first and a second SRS resource set and that the SDM transmission is associated with a first and a second activated Joint/uplink TCI state.

In some embodiments, one codepoint of the SRS resource set indication field indicates the PUSCH transmission scheme being the SFN transmission associated with a first and a second SRS resource set and that the PUSCH SFN transmission is associated with a first and a second activated Joint/uplink TCI state.

In some embodiments, the DCI message includes two precoding information and number of layers fields, and the size of which depends on the configured maximum of L_{max,1} layers over a first SRS resource set and L_{max,2} layers over a second SRS resource set for codebook (CB)-based transmission, both of the first and second SRS resource sets are within the plurality of SRS resource sets.

In some embodiments, the DCI message includes a SRS resource indicator field, and the maximum number of SRS resources that can be indicated by the SRS resource indicator field is the minimum of the configured maximum of L_{max,1} layers over a first SRS resource set and L_{max,2} layers over a second SRS resource set, both of the first and second SRS resource sets are within the plurality of SRS resource sets for non-codebook (NCB)-based transmission.

### 6. Devices Implementing Embodiments of the Invention

FIG. 11 illustrates an electronic device implementing simultaneous uplink transmission over multiple Sounding Reference Signal (SRS) resource sets per some embodiments. The electronic device may be a host in a cloud system, or a network node/UE in a wireless/wireline network, and the operating environment and further embodiments the host, the network node, the UE are discussed in more details herein below. The electronic device 1102 may be implemented using custom application-specific integrated-circuits (ASICs) as processors and a special-purpose operating system (OS), or common off-the-shelf (COTS) processors and a standard OS. In some embodiments, the electronic device 1102 implements uplink communication coordinator 1155 that may perform methods 900 and/or 1000.

The electronic device 1102 includes hardware 1140 comprising a set of one or more processors 1142 (which are typically COTS processors or processor cores or ASICs) and physical NIs 1146, as well as non-transitory machine-readable storage media 1149 having stored therein software 1150. During operation, the one or more processors 1142 may execute the software 1150 to instantiate one or more sets of one or more applications 1164A-R. While one embodiment does not implement virtualization, alternative embodiments may use different forms of virtualization. For example, in one such alternative embodiment, the virtualization layer 1154 represents the kernel of an operating system (or a shim executing on a base operating system) that allows for the creation of multiple instances 1162A-R called software containers that may each be used to execute one (or more) of the sets of applications 1164A-R. The multiple software containers (also called virtualization engines, virtual private servers, or jails) are user spaces (typically a virtual memory space) that are separate from each other and separate from the kernel space in which the operating system is run. The set of applications running in a given user space, unless explicitly allowed, cannot access the memory of the other processes. In another such alternative embodiment, the virtualization layer 1154 represents a hypervisor (sometimes referred to as a virtual machine monitor (VMM)) or a hypervisor executing on top of a host operating system, and each of the sets of applications 1164A-R run on top of a guest operating system within an instance 1162A-R called a virtual machine (which may in some cases be considered a tightly isolated form of software container) that run on top of the hypervisor—the guest operating system and application may not know that they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 1140, directly on a hypervisor (in which case the unikernel is sometimes described as running within a LibOS virtual machine), or in a software container, embodiments can be implemented fully with unikernels running directly on a hypervisor represented by virtualization layer 1154, unikernels running within software containers represented by instances 1162A-R, or as a combination of unikernels and the above-described techniques (e.g., unikernels and virtual machines both run directly on a hypervisor, unikernels, and sets of applications that are run in different software containers).

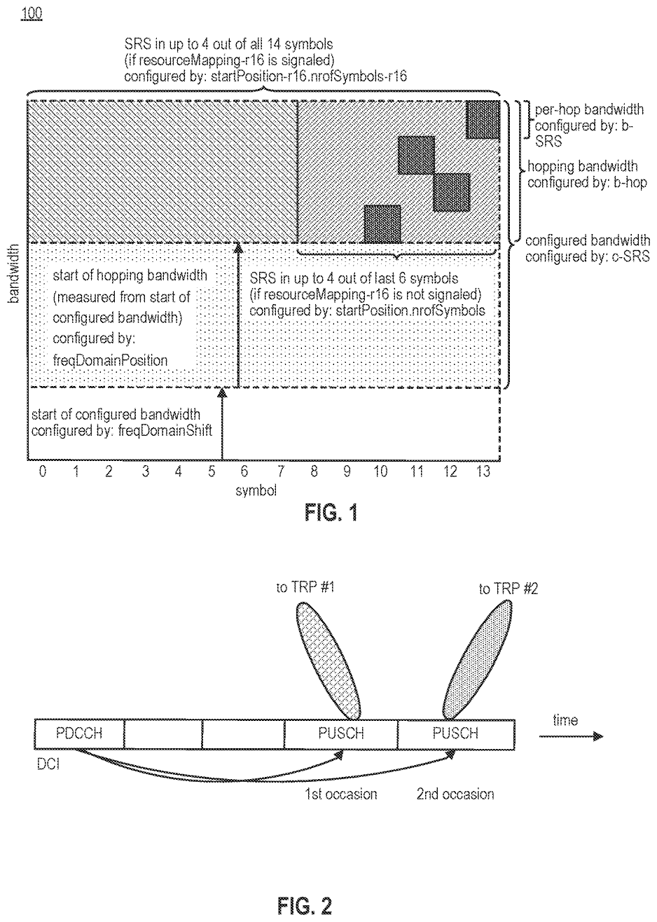

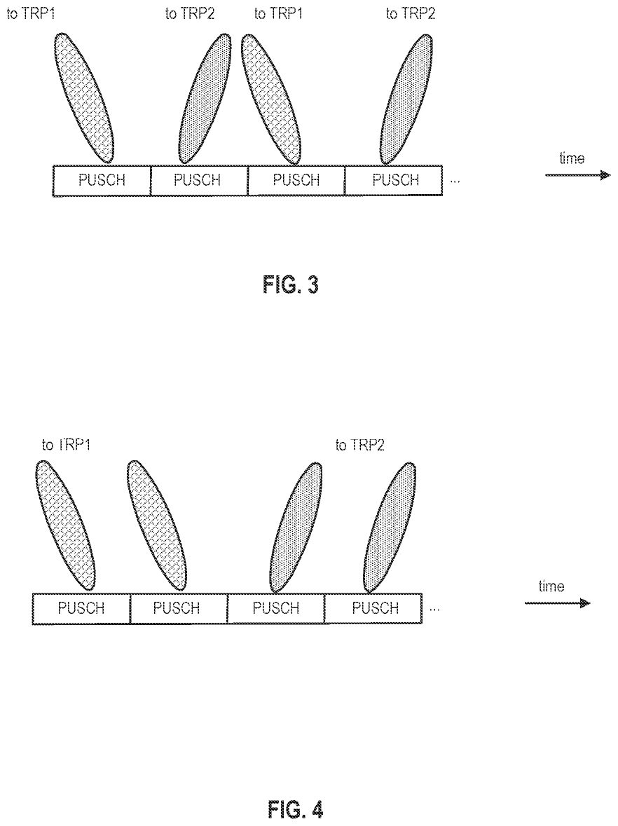

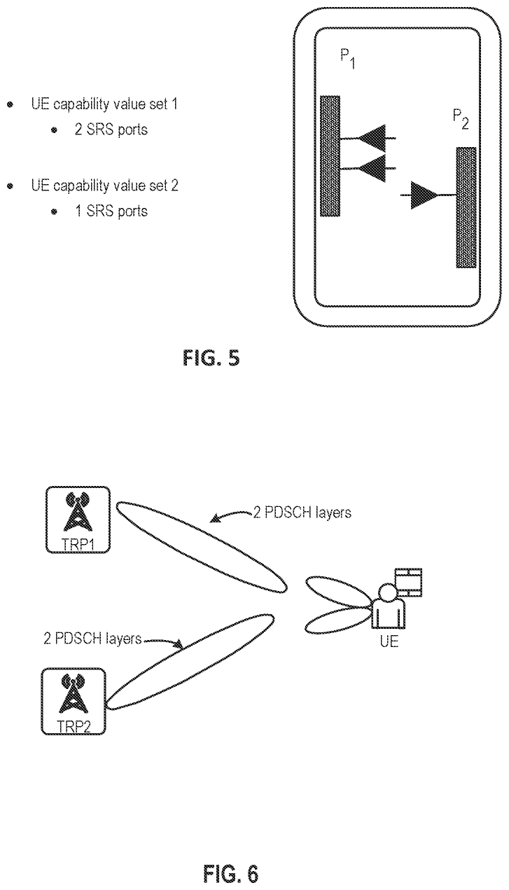

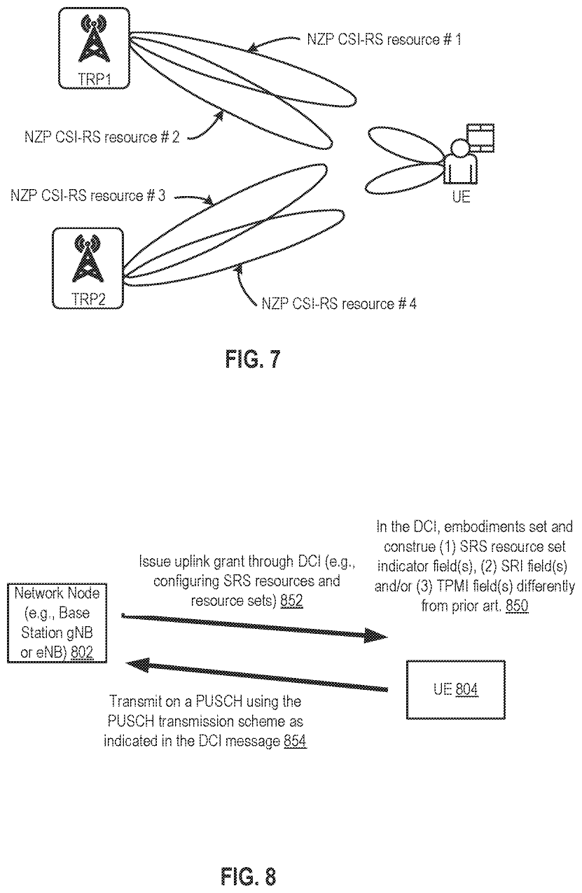

The software 1150 contains uplink communication coordinator 1155 that performs operations described with reference to operations as discussed relating to FIGS. 1 to 10. The uplink communication coordinator 1155 may be instantiated within the applications 1164A-R. The instantiation of the one or more sets of one or more applications 1164A-R, as well as virtualization if implemented, are collectively referred to as software instance(s) 1152. Each set of applications 1164A-R, corresponding virtualization construct (e.g., instance 1162A-R) if implemented, and that part of the hardware 1140 that executes them (be it hardware dedicated to that execution and/or time slices of hardware temporally shared), forms a separate virtual electronic device 1160A-R.

A network interface (NI) may be physical or virtual. In the context of IP, an interface address is an IP address assigned to an NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). The NI is shown as network interface card (NIC) 1144. The physical network interface 1146 may include one or more antenna of the electronic device 1102. An antenna port may or may not correspond to a physical antenna. The antenna comprises one or more radio interfaces.

### A Wireless Network per Some Embodiments

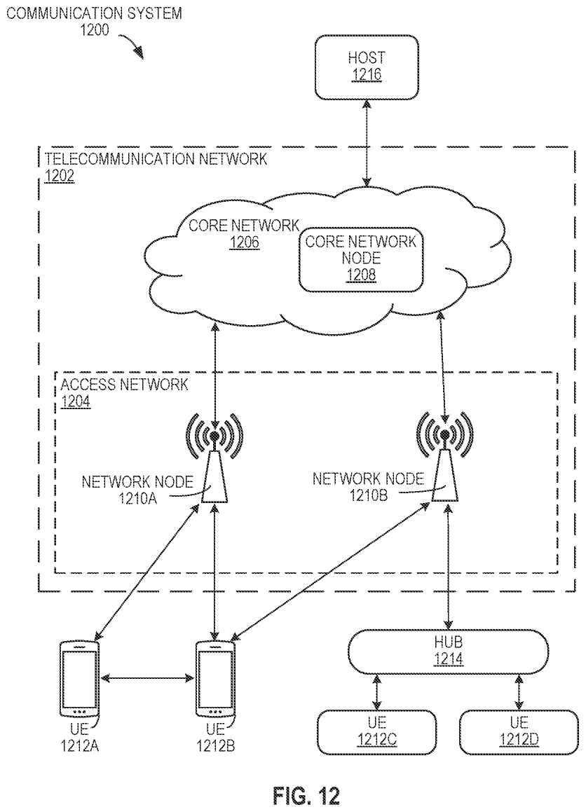

FIG. 12 illustrates an example of a communication system 1200 per some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3^{rd}Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more services. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

### UE Per Some Embodiments

FIG. 13 illustrates a UE 1300 per some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300.

Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

### Network Node Per Some Embodiments

FIG. 14 illustrates a network node 1400 per some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment.

Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

### Host Per Some Embodiments

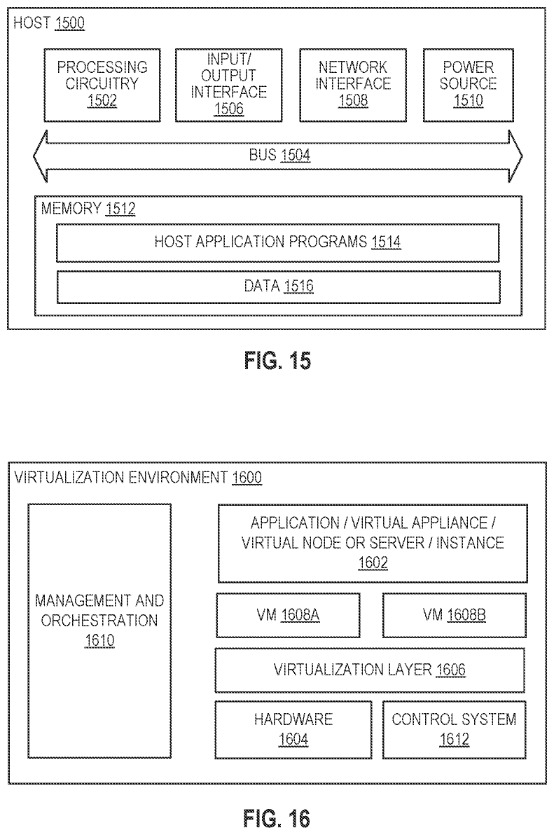

FIG. 15 is a block diagram of a host 1500, which may be an embodiment of the host 1216 of FIG. 12, per various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

### Virtualization Environment Per Some Embodiments

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment 1600 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606.

Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g., such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

### Communication Among Host, Network Node, and UE Per Some Embodiments

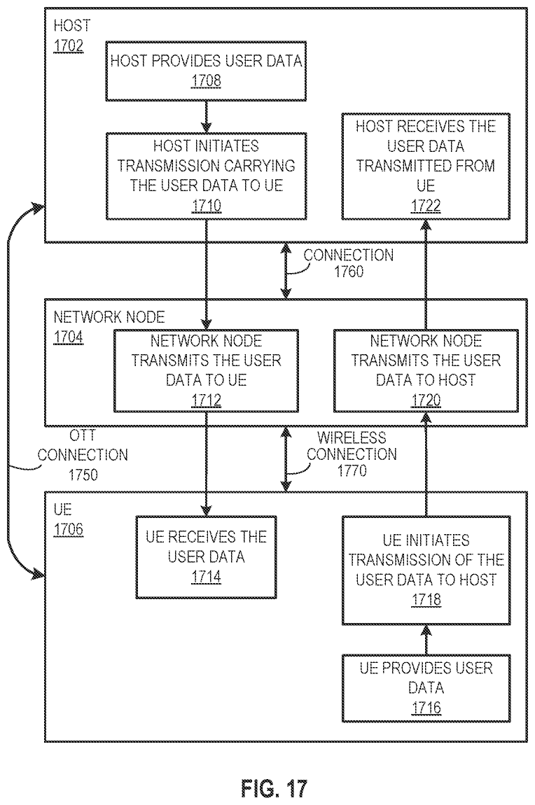

FIG. 17 illustrates a communication diagram of a host 1702 communicating via a network node 1704 with a UE 1706 over a partially wireless connection per some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

### 7. Radio Resources Used in a Wireless Network

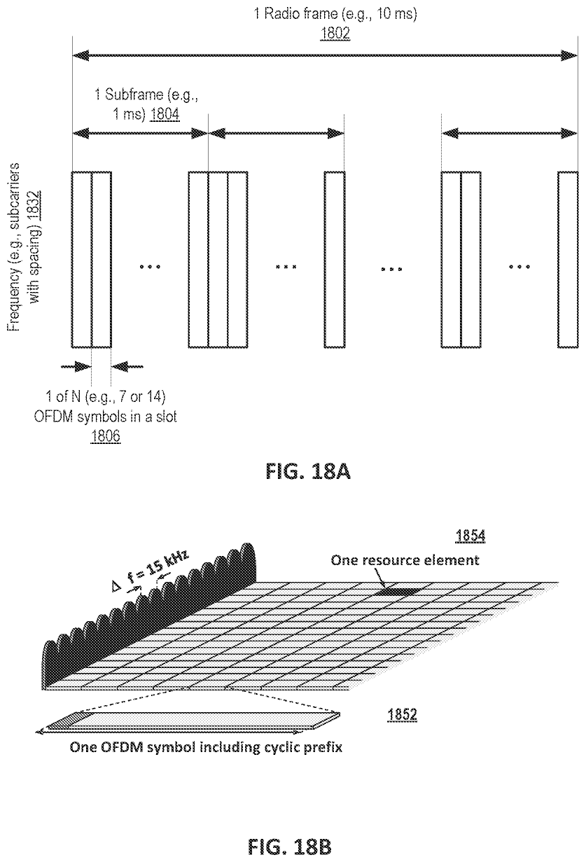

FIG. 18A shows an exemplary signal transmission hierarchy in a wireless network. The exemplary signal transmission hierarchy includes the transmission unit of frame such as radio frame 1802. A radio frame 1802 takes ten milliseconds to transmit in one embodiment. The frame may contain a number of subframes such as subframe 1804. In this example, the radio frame 1802 contains ten subframes, each takes one millisecond. Each subframe may contain a number of slots. For example, a subframe may contain two slots. Each slot such as the slot at reference 1806 may contain a number of symbols. In one example, a slot contains either 7 or 14 symbols. The symbol is an orthogonal frequency-division multiplexing (OFDM) symbol in one embodiment.

The frame—subframe—slot—symbol hierarchy is an example of time domain hierarchy. In the frequency domain (as illustrated at reference 1832), each symbol may be transmitted over a number of subcarriers. A symbol may be transmitted using a number of resource block (RB), each of which may contain 12 subcarriers in one embodiment. In one embodiment, each subcarrier includes a bandwidth (e.g., 7.5 kHz or 15 kHz) for transmission. One subcarrier×one symbol may be referred to as a resource element (RE), which is the smallest unit of resource to be allocated for signal transmission in one embodiment.

The illustrated frame structure offers an example for signal transmission. In this frame structure or other frame structures, data and signaling transmission is performed at a lowest level of time unit (symbol level in this case), which is included in a time unit (slot level in this example) a level over the lowest level of time unit in one embodiment. Data and signaling for one transmission from a source network device to a destination network device often use the same position within the signal transmission hierarchy, e.g., the same symbol position in consecutive slots (e.g., symbol #2 of each slot) or subframes, or in alternating slots (e.g., symbol #2 in every other slot) or subframes.

FIG. 18B shows resource elements used for data and signaling transmission. The physical resources for transmission may be view as time and frequency grids as illustrated, where each resource element occupies a time period in the time domain and a frequency range in the frequency domain. Each OFDM symbol includes a cyclic prefix as illustrated at reference 1852. Each OFDM symbol utilizes a number of resource elements. In this example, the sub-carrier spacing is 15k Hz, and the resource element (RE) 1852 occupies an orthogonal frequency-division multiplexing (OFDM) subcarriers within an OFDM symbol. A network device may allocate some resource elements for a particular type of signaling. Such allocation may be specified through identifying the time period in the time domain and the frequency range in the frequency domain in a signal transmission hierarchy; or it may be specified through identifying specific resource elements within the signal transmission hierarchy.

For downlink control, a wireless network may use PDCCHs (physical downlink channels) to transmit downlink control information (DCI), which provides downlink scheduling assignments and uplink scheduling grants. The PDCCHs are transmitted at the beginning of a slot and relate to data in the same or a later slot (for mini-slots PDCCH can also be transmitted within a regular slot) in some embodiments. Different formats (sizes) of the PDCCHs are possible to handle different DCI payload sizes and different aggregation levels (i.e. different code rate for a given payload size). A UE may be configured (implicitly and/or explicitly) to blindly monitor (or search) for a number of PDCCH candidates of different aggregation levels and DCI payload sizes. Upon detecting a valid DCI message (e.g., the decoding of a candidate being successful and the DCI contains an ID that the UE is told to monitor) the UE follows the DCI (e.g. receives the corresponding downlink data or transmits in the uplink). The blind decoding process comes at a cost in complexity in the UE but is required to provide flexible scheduling and handling of different DCI payload sizes.

Different NR use-cases (e.g., MBB (mobile broadband), URLLC (ultra-reliable low latency communication)) require different control regions (e.g., time, frequency, numerologies etc.) & PDCCH configurations (e.g., operating points etc.) PDCCHs in NR are transmitted in configurable/dynamic control regions called control resource sets (CORESET) enabling variable use-cases. A CORESET is a subset of the downlink physical resource configured to carry control signaling. It is analogous to the control region in LTE but generalized in the sense that the set of physical resource blocks (PRBs) and the set of OFDM symbols in which it is located is configurable.

In one embodiment, CORESET configuration in frequency allocation is done in units of 6 RBs using NR DL resource allocation Type 0: bitmap of RB groups (RBGs). CORESET configuration in time spans of 1-3 consecutive OFDM symbols. For slot-based scheduling, the CORESET span at the beginning of a slot is at most 2 if demodulation reference signal (DMRS) is located in OFDM Symbol (OS) #2 and is at most 3 if DMRS is located in OS #3. A UE monitors one or more CORESETs. Multiple CORESETs can be overlapped in frequency and time for a UE.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Embodiments

### Group A Embodiments

1. A method in a user equipment (UE) for transmitting on a Physical Uplink Channel (PUSCH) from one or more UE panels, the method comprising:
receiving one or more messages to configure a plurality of sounding reference signal (SRS) resource sets;
receiving a downlink control information (DCI) message to trigger a PUSCH transmission, where the DCI message includes a SRS resource set indication field to indicate a PUSCH transmission scheme, wherein the PUSCH transmission scheme is selected from a group of PUSCH transmission schemes that includes a single transmission and reception point (sTRP) transmission, a spatial division multiplexing (SDM) transmission, and a single frequency network (SFN) transmission;
transmitting on a PUSCH using the PUSCH transmission scheme as indicated in the DCI message.
   2. The method of embodiment 1, further comprising:
receiving a trigger message to transmit SRS ports associated with the plurality of SRS resource sets.
   3. The method of embodiment 1, wherein the SRS resource set indication field comprises two bits, and two out of four indices indicated through the two bits are interpreted as representing types of simultaneous multi-panel transmission (STxMP) schemes.
   4. The method of embodiment 3, wherein the two bits being interpreted as representing types of simultaneous PUSCH transmission schemes is based on the UE is Radio Resource Control (RRC) configured with the simultaneous PUSCH transmission schemes.
   5. The method of embodiment 4, wherein the two bits are interpreted as representing a PUSCH transmission scheme when no more than one PUSCH repetition is configured.
   6. The method of embodiment 1, wherein the PUSCH transmission scheme indicated in the SRS resource set field is the SFN transmission associated with both a first SRS resource set and a second SRS resource set within the plurality of SRS resource sets.
   7. The method of embodiment 1, wherein the PUSCH transmission scheme indicated in the SRS resource set field is the SDM transmission associated with both a first SRS resource set and a second SRS resource set within the plurality of SRS resource sets.
   8. The method of embodiment 7, wherein each of the first and second SRS resource sets is associated with a different set of uplink layers.
   9. The method of embodiment 1, wherein the SRS resource set indication field comprises three bits indicating eight possible permutations, at least two of which are interpreted as representing single sTRP transmission schemes.
   10. The method of embodiment 9, wherein at least four of the eight possible permutations are to indicate STxMP schemes.
   11. The method of embodiment 1, where one codepoint of the SRS resource set indication field indicates PUSCH sTRP transmission associated with a first SRS resource set and that the PUSCH sTRP transmission should be associated with a first activated Joint/uplink Transmission Configuration indication (TCI) states
   12. The method of embodiment 1, where one codepoint of the SRS resource set indication field indicates the PUSCH transmission scheme being the sTRP transmission associated with a second SRS resource set and that the sTRP transmission is associated with a second activated Joint/uplink TCI state
   13. The method of embodiment 1, where one codepoint of the SRS resource set indication field indicates the PUSCH transmission scheme being the SDM transmission associated with a first and a second SRS resource set and that the SDM transmission is associated with a first and a second activated Joint/uplink TCI state
   14. The method of embodiment 1, where one codepoint of the SRS resource set indication field indicates the PUSCH transmission scheme being the SFN transmission associated with a first and a second SRS resource set and that the PUSCH SFN transmission is associated with a first and a second activated Joint/uplink TCI state
   15. The method of embodiment 1, wherein the DCI message includes two precoding information and number of layers fields, and the size of which depends on the configured maximum of L_{max,1} layers over a first SRS resource set and L_{max,2} layers over a second SRS resource set for codebook (CB)-based transmission, both of the first and second SRS resource sets are within the plurality of SRS resource sets.
   16. The method of embodiment 1, wherein the DCI message includes a SRS resource indicator field, and the maximum number of SRS resources that can be indicated by the SRS resource indicator field is the minimum of the configured maximum of L_{max,1} layers over a first SRS resource set and L_{max,2} layers over a second SRS resource set, both of the first and second SRS resource sets are within the plurality of SRS resource sets for non-codebook (NCB)-based transmission.
   17. The method of embodiment 1, wherein different UE panels of the UE support different maximum number of uplink layers or SRS ports.
   18. The method of embodiment 17, wherein the UE indicates in a group-based beam report per reported beam, the maximum supported number of layers or maximum supported SRS ports of a UE panel associated with that reported beam.
   19. The method of embodiment 18, wherein the UE reports the maximum number of supported uplink layers or maximum number of supported SRS ports per UE panel by indicating a UE capability value set index per beam in the group-based beam report.
   20. The method of embodiment 1, wherein when the UE transmits through SRS ports from a first SRS resource set configured with two SRS ports from a UE panel that supports maximum one SRS ports, the UE drops transmission of one of the two SRS ports.
   21. The method of embodiment 20, wherein the UE drops one of the two SRS ports based on comparison of the corresponding SRS port indices.
   22. The method of embodiment 20, wherein the UE applies power on the remaining port that was applied on both of the two SRS ports.
   23. The method of embodiment 1, wherein the plurality of SRS resource sets includes a first, a second, and a third SRS resource sets, wherein when the first and second SRS resource sets are used for simultaneous multi-panel transmission (STxMP), the third SRS resource set is deactivated, and wherein when the third SRS resource set is used for a sTRP transmission, the first and second SRS resource sets are deactivated.
   24. The method of embodiment 23, wherein an SRS resource set information element indicates whether STxMP or sTRP transmission should be activated.

### Group B Embodiments

25. A method performed by a network node for coordinating transmitting on a Physical Uplink Channel (PUSCH) from one or more UE panels the method comprising:
configuring a user equipment (UE) with a plurality of sounding reference signal (SRS) resource sets;
determining a PUSCH transmission scheme for communication with the UE, wherein each of the PUSCH transmission scheme is selected from a group of transmission schemes including a single transmission and reception point (sTRP) transmission, a spatial division multiplexing (SDM) transmission, and a single frequency network (SFN) transmission; and
causing the UE to use the PUSCH transmission scheme through transmitting to the UE a downlink control information (DCI) message in which an SRS resource set indicator field is set to indicate the PUSCH transmission scheme.
   26. The method of embodiment 25, further comprising:
transmitting a trigger message to cause the UE to transmit SRS ports associated with the plurality of SRS resource sets.
   27. The method of embodiment 25, wherein the SRS resource set indication field comprises two bits, and two out of four indices indicated through the two bits are interpreted as representing types of simultaneous multi-panel transmission (STxMP) schemes.
   28. The method of embodiment 27, wherein the two bits being interpreted as representing types of simultaneous PUSCH transmission schemes is based on the UE is Radio Resource Control (RRC) configured with the simultaneous PUSCH transmission schemes.
   29. The method of embodiment 28, wherein the two bits are interpreted as representing a PUSCH transmission scheme when no more than one PUSCH repetition is configured.
   30. The method of embodiment 25, wherein the PUSCH transmission scheme indicated in the SRS resource set field is the SFN transmission associated with both a first SRS resource set and a second SRS resource set within the plurality of SRS resource sets.
   31. The method of embodiment 25, wherein the PUSCH transmission scheme indicated in the SRS resource set field is the SDM transmission associated with both a first SRS resource set and a second SRS resource set within the plurality of SRS resource sets.
   32. The method of embodiment 31, wherein each of the first and second SRS resource sets is associated with a different set of uplink layers.
   33. The method of embodiment 25, wherein the SRS resource set indication field comprises three bits indicating eight possible permutations, at least two of which are interpreted as representing single sTRP transmission schemes.
   34. The method of embodiment 33, wherein at least four of the eight possible permutations are to indicate STxMP schemes.
   35. The method of embodiment 25, where one codepoint of the SRS resource set indication field indicates PUSCH sTRP transmission associated with a first SRS resource set and that the PUSCH sTRP transmission should be associated with a first activated Joint/uplink Transmission Configuration indication (TCI) states
   36. The method of embodiment 25, where one codepoint of the SRS resource set indication field indicates the PUSCH transmission scheme being the sTRP transmission associated with a second SRS resource set and that the sTRP transmission is associated with a second activated Joint/uplink TCI state
   37. The method of embodiment 25, wherein one codepoint of the SRS resource set indication field indicates the PUSCH transmission scheme being the SDM transmission associated with a first and a second SRS resource set and that the SDM transmission is associated with a first and a second activated Joint/uplink TCI state
   38. The method of embodiment 25, where one codepoint of the SRS resource set indication field indicates the PUSCH transmission scheme being the SFN transmission associated with a first and a second SRS resource set and that the PUSCH SFN transmission is associated with a first and a second activated Joint/uplink TCI state
   39. The method of embodiment 25, wherein the DCI message includes two precoding information and number of layers fields, and the size of which depends on the configured maximum of L_{max,1} layers over a first SRS resource set and L_{max,2} layers over a second SRS resource set for codebook (CB)-based transmission, both of the first and second SRS resource sets are within the plurality of SRS resource sets.
   40. The method of embodiment 25, wherein the DCI message includes a SRS resource indicator field, and the maximum number of SRS resources that can be indicated by the SRS resource indicator field is the minimum of the configured maximum of L_{max,1} layers over a first SRS resource set and L_{max,2} layers over a second SRS resource set, both of the first and second SRS resource sets are within the plurality of SRS resource sets for non-codebook (NCB)-based transmission.
   41. The method of embodiment 25, wherein different UE panels of the UE support different maximum number of uplink layers or SRS ports.
   42. The method of embodiment 41, wherein the UE indicates in a group-based beam report per reported beam, the maximum supported number of layers or maximum supported SRS ports of a UE panel associated with that reported beam.
   43. The method of embodiment 42, wherein the UE reports the maximum number of supported uplink layers or maximum number of supported SRS ports per UE panel by indicating a UE capability value set index per beam in the group-based beam report.
   44. The method of embodiment 25, wherein when the UE transmits through SRS ports from a first SRS resource set configured with two SRS ports from a UE panel that supports maximum one SRS ports, the UE drops transmission of one of the two SRS ports.
   45. The method of embodiment 44, wherein the UE drops one of the two SRS ports based on comparison of the corresponding SRS port indices.
   46. The method of embodiment 45, wherein the UE applies power on the remaining port that was applied on both of the two SRS ports.
   47. The method of embodiment 25, wherein the plurality of SRS resource sets includes a first, a second, and a third SRS resource sets, wherein when the first and second SRS resource sets are used for simultaneous multi-panel transmission (STxMP), the third SRS resource set is deactivated, and wherein when the third SRS resource set is used for a sTRP transmission, the first and second SRS resource sets are deactivated.
   48. The method of embodiment 47, wherein an SRS resource set information element indicates whether STxMP or sTRP transmission should be activated.

### Group C Embodiments

49. A user equipment for transmitting on a Physical Uplink Channel (PUSCH) from one or more UE panels, comprising:
processing circuitry configured to perform any of the steps of any of the Group A embodiments; and
power supply circuitry configured to supply power to the processing circuitry.
   50. A network node for transmitting on a Physical Uplink Channel (PUSCH) from one or more UE panels, the network node comprising:
processing circuitry configured to perform any of the steps of any of the Group B embodiments;
power supply circuitry configured to supply power to the processing circuitry.
   51. A user equipment (UE) for transmitting on a Physical Uplink Channel (PUSCH) from one or more UE panels, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and a battery connected to the processing circuitry and configured to supply power to the UE.

1. A method in a user equipment (UE) for transmitting a Physical Uplink Shared Channel (PUSCH) simultaneously from one or more UE panels, the method comprising:
receiving one or more messages to configure a plurality of sounding reference signal (SRS) resource sets;
receiving a downlink control information (DCI) message to trigger a PUSCH transmission, where the DCI message includes an SRS resource set indication field to indicate a PUSCH transmission scheme, wherein the PUSCH transmission scheme is selected from a group of PUSCH transmission schemes that includes two or more of a single transmission and reception point (sTRP) transmission, a spatial division multiplexing (SDM) transmission, and a single frequency network (SFN) transmission; and
transmitting the PUSCH using the PUSCH transmission scheme as indicated in the DCI message.

2. The method of claim 1, further comprising:
receiving a trigger message to transmit SRS ports associated with the plurality of SRS resource sets.

3. The method of claim 1, wherein the SRS resource set indication field comprises two bits, and two out of four indices indicated through the two bits are interpreted as representing types of simultaneous multi-panel transmission (STxMP) schemes.

4. The method of claim 3, wherein the two bits being interpreted as representing types of simultaneous PUSCH transmission schemes is based on that the UE is Radio Resource Control (RRC) configured with the simultaneous PUSCH transmission schemes.

5. The method of claim 1, wherein the PUSCH transmission scheme indicated in the SRS resource set field is the SFN transmission associated with both a first SRS resource set and a second SRS resource set within the plurality of SRS resource sets, wherein each of the first and second SRS resource sets is associated with the same set of uplink layers.

6. The method of claim 1, wherein the PUSCH transmission scheme indicated in the SRS resource set field is the SDM transmission associated with both a first SRS resource set and a second SRS resource set within the plurality of SRS resource sets, wherein each of the first and second SRS resource sets is associated with a different set of uplink layers.

7-14. (canceled)

15. The method of claim 1, wherein different UE panels of the UE support different maximum number of uplink layers or SRS ports, wherein the UE indicates in a group-based beam report per reported beam, the maximum supported number of layers or maximum supported SRS ports of a UE panel associated with that reported beam, and wherein the UE reports the maximum number of supported uplink layers or maximum number of supported SRS ports per UE panel by indicating a UE capability value set index per beam in the group-based beam report.

16. The method of claim 1, wherein when the UE transmits through SRS ports from a first SRS resource set configured with two SRS ports from a UE panel that supports maximum one SRS ports, the UE drops transmission of one of the two SRS ports, wherein the UE drops one of the two SRS ports based on comparison of the corresponding SRS port indices, and wherein the UE applies power on the remaining port that was applied on both of the two SRS ports.

17. (canceled)

18. A user equipment for transmitting on a Physical Uplink Shared Channel (PUSCH) from one or more UE panels, comprising:
power supply circuitry configured to supply power to processing circuitry and the processing circuitry configured to:
receive one or more messages to configure a plurality of sounding reference signal (SRS) resource sets;
receive a downlink control information (DCI) message to trigger a PUSCH transmission, where the DCI message includes an SRS resource set indication field to indicate a PUSCH transmission scheme, wherein the PUSCH transmission scheme is selected from a group of PUSCH transmission schemes that includes two or more of a single transmission and reception point (sTRP) transmission, a spatial division multiplexing (SDM) transmission, and a single frequency network (SFN) transmission; and
transmit the PUSCH using the PUSCH transmission scheme as indicated in the DCI message.

19. (canceled)

20. A method performed by a network node for coordinating transmission a Physical Uplink Shared Channel (PUSCH) simultaneously from one or more UE panels, the method comprising:
configuring a user equipment (UE) with a plurality of sounding reference signal (SRS) resource sets;
determining a PUSCH transmission scheme for communication with the UE, wherein each of the PUSCH transmission scheme is selected from a group of two or more transmission schemes including a single transmission and reception point (sTRP) transmission, a spatial division multiplexing (SDM) transmission, and a single frequency network (SFN) transmission; and
causing the UE to use the PUSCH transmission scheme through transmitting to the UE a downlink control information (DCI) message in which an SRS resource set indicator field is set to indicate the PUSCH transmission scheme.

21. (canceled)

22. The method of claim 20, wherein the SRS resource set indication field comprises two bits, and two out of four indices indicated through the two bits are interpreted as representing types of simultaneous multi-panel transmission (STxMP) schemes.

23. (canceled)

24. The method of claim 20, wherein the PUSCH transmission scheme indicated in the SRS resource set field is the SFN transmission associated with both a first SRS resource set and a second SRS resource set within the plurality of SRS resource sets, wherein each of the first and second SRS resource sets is associated with the same set of uplink layers.

25. The method of claim 20, wherein the PUSCH transmission scheme indicated in the SRS resource set field is the SDM transmission associated with both a first SRS resource set and a second SRS resource set within the plurality of SRS resource sets, wherein each of the first and second SRS resource sets is associated with a different set of uplink layers.

26. The method of claim 20, where one codepoint of the SRS resource set indication field indicates the PUSCH transmission scheme as being:
the sTRP transmission associated with a first SRS resource set and that the PUSCH sTRP transmission is associated with a first activated joint/uplink Transmission Configuration indication (TCI) state,
the sTRP transmission associated with a second SRS resource set and that the sTRP transmission is associated with a second activated joint/uplink TCI state, or
the SDM transmission associated with a first and a second SRS resource set and that the SDM transmission is associated with a first and a second activated joint/uplink TCI state.

27. The method of claim 20, where one codepoint of the SRS resource set indication field indicates the PUSCH transmission scheme as being:
the sTRP transmission associated with a first SRS resource set and that the sTRP transmission is associated with a first activated joint/uplink TCI state,
the sTRP transmission associated with a second SRS resource set and that the sTRP transmission is associated with a second activated joint/uplink TCI state, or
the SFN transmission associated with a first and a second SRS resource set and that the SFN transmission is associated with a first and a second activated joint/uplink TCI state.

28. The method of claim 20, wherein the DCI message includes two precoding information and number of layers fields, the size of which depends on the configured maximum of L_{max,1} layers over a first SRS resource set and L_{max,2} layers over a second SRS resource set for codebook (CB)-based transmission, both of the first and second SRS resource sets are within the plurality of SRS resource sets.

29. The method of claim 20, wherein the DCI message includes two SRS resource indicator fields, and the maximum number of SRS resources that can be indicated by the SRS resource indicator field is the minimum of the configured maximum of L_{max,1} layers over a first SRS resource set and L_{max,2} layers over a second SRS resource set, both of the first and second SRS resource sets are within the plurality of SRS resource sets for non-codebook (NCB)-based transmission.

30. The method of claim 20, wherein the DCI message includes two precoding information and number of layers fields, the size of which depends on the configured maximum number of Lₘₐₓ/2 layers over one or more of a first and second SRS resource set, both of the first and second SRS resource set are within the plurality of SRS resource sets for codebook (CB)-based transmission, and Lₘₐₓ is the maximum number of layers supported by the UE.

31. The method of claim 20, wherein the DCI message includes two precoding information and number of layers fields, the size of which depends on the configured maximum number of Lₘₐₓ layers over one of a first or second SRS resource set, both of the first and second SRS resource set are within the plurality of SRS resource sets for codebook (CB)-based transmission, and Lₘₐₓ is the maximum number of layers supported by the UE.

32. The method of claim 20, wherein the DCI message includes two SRS resource indicator fields, and the maximum number of SRS resources that can be indicated by an SRS resource indicator field is Lₘₐₓ/2 layers over one or more of a first and second SRS resource set, both of the first and second SRS resource set are within the plurality of SRS resource sets for non-codebook (NCB)-based transmission, and Lₘₐₓ is the maximum number of layers supported by the UE.

33. The method of claim 20, wherein the DCI message includes two SRS resource indicator fields, and the maximum number of SRS resources that can be indicated by an SRS resource indicator field is Lₘₐₓ layers over one of a first or second SRS resource set, both of the first and second SRS resource set are within the plurality of SRS resource sets for non-codebook (NCB)-based transmission, and Lₘₐₓ is the maximum number of layers supported by the UE.

34. (canceled)

35. (canceled)

36. The method of claim 20, wherein the plurality of SRS resource sets includes a first, a second, and a third SRS resource sets, wherein when the first and second SRS resource sets are used for simultaneous multi-panel transmission (STxMP), the third SRS resource set is deactivated, and wherein when the third SRS resource set is used for a sTRP transmission, the first and second SRS resource sets are deactivated, and wherein an SRS resource set information element indicates whether STxMP or sTRP transmission should be activated.

37. A network node for coordinating transmission of a Physical Uplink Shared Channel (PUSCH) simultaneously from one or more UE panels, the network node comprising:
power supply circuitry configured to supply power to processing circuitry; and
processing circuitry configured to:
configure a UE with a plurality of sounding reference signal (SRS) resource sets;
determine a PUSCH transmission scheme for communication with the UE, wherein each of the PUSCH transmission scheme is selected from a group of two or more transmission schemes including a single transmission and reception point (sTRP) transmission, a spatial division multiplexing (SDM) transmission, and a single frequency network (SFN) transmission; and
cause the UE to use the PUSCH transmission scheme through transmitting to the UE a downlink control information (DCI) message in which an SRS resource set indicator field is set to indicate the PUSCH transmission scheme.
